(19) United States
(12) Patent Application Publication
(10) Pub. No.: US 2018/0326992 A1
(43) Pub. Date: Nov. 15, 2018

(54) DRIVER MONITORING APPARATUS AND DRIVER MONITORING METHOD

(71) Applicant: OMRON Corporation, KYOTO (JP)

(72) Inventors: Hatsumi AOI, Kyotanabe-shi (JP); Kazuyoshi OKAJI, Omihachiman-shi (JP); Hiroshi SUGAHARA, Kyoto-shi (JP); Michie UNO, Kyoto-shi (JP); Koji TAKIZAWA, Kyoto-shi (JP)

(73) Assignee: OMRON Corporation, KYOTO (JP)

(21) Appl. No.: 15/952,285

(22) Filed: Apr. 13, 2018

(30) Foreign Application Priority Data
May 9, 2017 (JP) 2017-092844

(51) Int. Cl. B60W 50/08; G06K 9/00; G06K 9/62; G05D 1/00

(52) U.S. Cl. CPC B60W 50/08; G06K 9/00845; G06K 9/627; G06K 9/6256; G05D 1/0061; G05D 1/0088; G05D 2201/0213; B60W 2420/42; B60W 2540/00; G06K 9/00382

(57) ABSTRACT

A driver monitoring apparatus for monitoring a driver sitting in a driver seat in a vehicle provided with an autonomous driving mode and a manual driving mode includes: an image acquiring portion configured to acquire a driver image captured by a driver image capturing camera; an image storage portion configured to store the driver image acquired by the image acquiring portion; a determination processing portion configured to process the driver image read out from the image storage portion and determine whether or not a steering wheel of the vehicle is being gripped by a hand of the driver, if the autonomous driving mode is to be switched to the manual driving mode; and a signal output portion configured to output a predetermined signal that is based on a result of the determination performed by the determination processing portion.

### CROSS-REFERENCES TO RELATED APPLICATIONS

This application claims priority to Japanese Patent Application No. 2017-092844 filed May 9, 2017, the entire contents of which are incorporated herein by reference.

### FIELD

The disclosure relates to a driver monitoring apparatus and a driver monitoring method, and relates more particularly to a driver monitoring apparatus and a driver monitoring method for monitoring a driver of a vehicle that is provided with an autonomous driving mode and a manual driving mode.

### BACKGROUND

In recent years, research and development have been actively conducted to realize autonomous driving, i.e. autonomously controlling traveling of a vehicle. Autonomous driving technology is classified into several levels, ranging from a level at which at least part of traveling control, which includes acceleration and deceleration, steering, and braking, is automated, to a level of complete automation.

At an automation level at which vehicle operations and peripheral monitoring are performed by an autonomous driving system (e.g. level 3 at which acceleration, steering, and braking are entirely performed by the autonomous driving system, and a driver performs control when requested by the autonomous driving system), a situation is envisioned where an autonomous driving mode is switched to a manual driving mode in which the driver drives the vehicle, depending on factors such as the traffic environment. It is, for example, a situation where, although autonomous driving is possible on an expressway, the autonomous driving system requests the driver to manually drive the vehicle near an interchange.

In the autonomous driving mode at the aforementioned level 3, the driver is basically relieved from performing driving operations, and accordingly, the driver may perform an operation other than driving or may be less vigilant during autonomous driving. For this reason, when the autonomous driving mode is switched to the manual driving mode, the driver needs to be in a state of being able to take over the steering wheel operation and pedaling operation of the vehicle from the autonomous driving system, in order to ensure safety of the vehicle. A state where the driver can take over those operations from the autonomous driving system refers to, for example, a state where the driver is gripping a steering wheel.

As for a configuration for detecting a steering wheel operation performed by a driver, for example, a gripped state of a steering wheel is considered to be detectable when the autonomous driving mode is switched to the manual driving mode, by using a gripping-detection device disclosed in Patent Document 1 below.

However, with the gripping-detection device described in Patent Document 1, it cannot be accurately determined whether or not a hand that is in contact with the steering wheel is actually a driver's hand. For example, it will be determined that the driver is gripping the steering wheel even if a passenger other than the driver (a person in a passenger seat or a rear seat) other than the driver is gripping the steering wheel.

In the case of using the aforementioned gripping-detection device, when the autonomous driving mode is switched to the manual driving mode, there is concern that the driving mode will switch to autonomous driving even if a passenger other than the driver is gripping the steering wheel, and the safety of the vehicle cannot be ensured.

JP 2016-203660 is an example of background art.

### SUMMARY

One or more embodiments have been made in view of the foregoing problem, and aims to provide a driver monitoring apparatus and a driver monitoring method with which, if the autonomous driving mode is to be switched to the manual driving mode, whether or not the original driver sitting in the driver seat is gripping the steering wheel can be accurately detected.

To achieve the above-stated object, a driver monitoring apparatus (1) according to one or more embodiments is a driver monitoring apparatus that monitors a driver sitting in a driver seat in a vehicle provided with an autonomous driving mode and a manual driving mode, the apparatus including;

an image acquiring portion configured to acquire a driver image captured by an image capturing portion for capturing an image of the driver;

an image storage portion configured to store the driver image acquired by the image acquiring portion;

a determination processing portion configured to, if the autonomous driving mode is to be switched to the manual driving mode, process the driver image read out from the image storage portion to determine whether or not a steering wheel of the vehicle is being gripped by a hand of the driver; and

a signal output portion configured to output a predetermined signal that is based on a result of the determination performed by the determination processing portion.

With the above-described driver monitoring apparatus (1), if the autonomous driving mode is to be switched to the manual driving mode, the driver image is processed to determine whether or not the steering wheel is being gripped by a hand of the driver, and the predetermined signal that is based on the result of the determination is output. A distinction can be made from a state where a passenger other than the driver is gripping the steering wheel, by using the driver image in the determination processing performed by the determination processing portion. Thus, whether or not the original driver sitting in the driver seat is gripping the steering wheel can be accurately detected.

A driver monitoring apparatus (2) according to one or more embodiments is the above-described driver monitoring apparatus (1), in which the driver image is an image obtained by capturing an image of a field of view, which at least includes a portion of a shoulder to an upper arm of the driver, and a portion of the steering wheel, and

the determination processing portion includes:

a gripping position detecting portion configured to process the driver image to detect a gripping position on the steering wheel;

a position detecting portion configured to process the driver image to detect a position of a shoulder and arm of the driver; and

a gripping determining portion configured to determine whether or not the steering wheel is being gripped by the hand of the driver, based on the gripping position detected by the gripping position detecting portion, and the position of the shoulder and arm of the driver detected by the position detecting portion.

With the above-described driver monitoring apparatus (2), whether or not the steering wheel is being gripped by a hand of the driver is determined based on the gripping position on the steering wheel that is detected by processing the driver image, and the position of the shoulder and arm of the driver. Accordingly, a clear distinction can be made from a state where a passenger other than the driver is gripping the steering wheel, and whether or not the original driver sitting in the driver seat is gripping the steering wheel can be more accurately detected.

A driver monitoring apparatus (3) according to one or more embodiments is the above-described driver monitoring apparatus (1), in which the driver image is an image obtained by capturing an image of a field of view, which at least includes a portion of a shoulder to an upper arm of the driver,

the driver monitoring apparatus further includes a contact signal acquiring portion configured to acquire a signal from a contact detecting portion that is provided in the steering wheel and detects contact with a hand, and

the determination processing portion includes:

a gripping position detecting portion configured to detect a gripping position on the steering wheel based on the contact signal acquired by the contact signal acquiring portion;

a position detecting portion configured to process the driver image to detect a position of a shoulder and arm of the driver; and

a gripping determining portion configured to determine whether or not the steering wheel is being gripped by the hand of the driver, based on the gripping position detected by the gripping position detecting portion, and the position of the shoulder and arm of the driver detected by the position detecting portion.

With the above-described driver monitoring apparatus (3), whether or not the steering wheel is being gripped by a hand of the driver is determined based on the gripping position on the steering wheel that is detected based on the contact signal from the contact detecting portion, and the position of the shoulder and arm of the driver that is detected by processing the driver image. Accordingly, even if the steering wheel does not appear in the driver image, a distinction can be made from a state where a passenger other than the driver is gripping the steering wheel, and whether or not the original driver sitting in the driver seat is gripping the steering wheel can be accurately detected.

A driver monitoring apparatus (4) according to one or more embodiments is the above-described driver monitoring apparatus (2) or (3), in which, if the gripping position is not detected by the gripping position detecting portion, the signal output portion outputs a signal for causing a warning portion provided in the vehicle to execute warning processing for making the driver grip the steering wheel.

With the above-described driver monitoring apparatus (4), if the gripping position is not detected by the gripping position detecting portion, warning processing for making the driver grip the steering wheel is executed. Accordingly, the driver can be prompted to grip the steering wheel.

A driver monitoring apparatus (5) according to one or more embodiments is the above-described driver monitoring apparatus (1), further including;

a classifier storage portion configured to store a trained classifier created by performing, in advance, learning processing by using, as training data, images of the driver who is gripping the steering wheel and images of the driver who is not gripping the steering wheel,

wherein the trained classifier includes an input layer to which data of the driver image read out from the image storage portion is input, and an output layer that outputs determination data regarding whether or not the steering wheel is being gripped by the hand of the driver, and

if the autonomous driving mode is to be switched to the manual driving mode, the determination processing portion performs processing to input the data of the driver image to the input layer of the trained classifier read out from the classifier storage portion, and output, from the output layer, the determination data regarding whether or not the steering wheel is being gripped by the hand of the driver.

With the above-described driver monitoring apparatus (5), if the autonomous driving mode is to be switched to the manual driving mode, determination data regarding whether or not the steering wheel is being gripped by a hand of the driver is output from the output layer by inputting the driver image data to the input layer of the trained classifier. Accordingly, a distinction can be made from a state where a passenger other than the driver is gripping the steering wheel, by using the trained classifier in the processing performed by the determination processing portion. Thus, whether or not the original driver sitting in the driver seat is gripping the steering wheel can be accurately detected.

A driver monitoring apparatus (6) according to one or more embodiments is the above-described driver monitoring apparatus (1), further including;

a classifier information storage portion configured to store definition information regarding an untrained classifier including the number of layers in a neural network, the number of neurons in each layer, and a transfer function, and constant data including a weight and a threshold for neurons in each layer obtained, in advance, through learning processing; and

a trained classifier creating portion configured to read out the definition information and the constant data from the classifier information storage portion to create a trained classifier,

wherein the trained classifier includes an input layer to which data of the driver image read out from the image storage portion is input, and an output layer that outputs determination data regarding whether or not the steering wheel is being gripped by the hand of the driver, and

if the autonomous driving mode is to be switched to the manual driving mode, the determination processing portion performs processing to input the data of the driver image to the input layer of the trained classifier created by the trained classifier creating portion, and output, from the output layer, the determination data regarding whether or not the steering wheel is being gripped by the hand of the driver.

With the above-described driver monitoring apparatus (6), if the autonomous driving mode is to be switched to the manual driving mode, a trained classifier is created, the driver image data is input to the input layer thereof, and thus, determination data regarding whether or not the steering wheel is being gripped by a hand of the driver is output from the output layer. Accordingly, a distinction can be made from a state where a passenger other than the driver is gripping the steering wheel, by using the trained classifier in the processing performed by the determination processing portion. Thus, whether or not the original driver sitting in the driver seat is gripping the steering wheel can be accurately detected.

A driver monitoring apparatus (7) according to one or more embodiments is any of the above-described driver monitoring apparatuses (1) to (6), in which, if it is determined by the determination processing portion that the steering wheel is being gripped by the hand of the driver, the signal output portion outputs a signal for permitting switching from the autonomous driving mode to the manual driving mode.

With the above-described driver monitoring apparatus (7), if it is determined that the steering wheel is being gripped by a hand of the driver, a signal for permitting switching from the autonomous driving mode to the manual driving mode is output. Accordingly the autonomous driving mode can be switched to the manual driving mode in a state where the driver has taken over steering wheel operations, land safety of the vehicle at the time of the switching can be ensured.

A driver monitoring apparatus (8) according to one or more embodiments is any of the above-described driver monitoring apparatuses (1) to (6), in which, if it is determined by the determination processing portion that the steering wheel is not being gripped by the hand of the driver, the signal output portion outputs a signal for not permitting switching from the autonomous driving mode to the manual driving mode.

With the above-described driver monitoring apparatus (8), if it is determined that the steering wheel is not being gripped by a hand of the driver, a signal for not permitting switching from the autonomous driving mode to the manual driving mode is output. Accordingly, it is possible to prevent switching to the manual driving mode in a state where the driver has not taken over steering wheel operations.

A driver monitoring method according to one or more embodiments is a driver monitoring method for monitoring a driver sitting in a driver seat in a vehicle provided with an autonomous driving mode and a manual driving mode, by using an apparatus including a storage portion and a hardware processor connected to the storage portion,

the storage portion including an image storage portion configured to store a driver image captured by an image capturing portion for capturing an image of the driver,

the method including:

acquiring the driver image captured by the image capturing portion, by the hardware processor, if the autonomous driving mode is to be switched to the manual driving mode;

causing the image storage portion to store the acquired driver image, by the hardware processor;

reading out the driver image from the image storage portion, by the hardware processor;

processing the read driver image to determine whether or not a steering wheel of the vehicle is being gripped by a hand of the driver, by the hardware processor; and

outputting a predetermined signal that is based on a result of the determination, by the hardware processor.

With the above-described driver monitoring method, if the autonomous driving mode is to be switched to the manual driving mode, the driver image captured by the image capturing portion is acquired, the image storage portion is caused to store the acquired driver image, the driver image is read out from the image storage portion, the driver image is processed to determine whether or not the steering wheel is being gripped by a hand of the driver, and the predetermined signal that is based on the result of the determination is output. Accordingly, a distinction can be made from a state where a passenger other than the driver is gripping the steering wheel, by using the driver image in the determining. Thus, whether or not the original driver sitting in the driver seat is gripping the steering wheel can be accurately detected.

### BRIEF DESCRIPTION OF THE DRAWINGS

FIG. 1 is a block diagram illustrating a configuration of essential parts of an autonomous driving system that includes a driver monitoring apparatus according to Embodiment (1).

FIG. 2 is a block diagram illustrating a hardware configuration of a driver monitoring apparatus according to Embodiment (1).

FIG. 3A is a diagram illustrating an example of a driver image captured by a driver image capturing camera, and FIG. 3B is a diagram illustrating an example of a determination table that is stored in a gripping determination method storage portion.

FIG. 4 is a flowchart illustrating a processing operation performed by a control unit in a driver monitoring apparatus according to Embodiment (1).

FIG. 5 is a flowchart illustrating a gripping determination processing operation performed by a control unit in a driver monitoring apparatus according to Embodiment (1).

FIG. 6 is a block diagram illustrating a configuration of essential parts of an autonomous driving system that includes a driver monitoring apparatus according to Embodiment (2).

FIG. 7 is a block diagram illustrating a hardware configuration of a driver monitoring apparatus according to Embodiment (2).

FIG. 8 is a flowchart illustrating a gripping determination processing operation performed by a control unit in a driver monitoring apparatus according to Embodiment (2).

FIG. 9 is a block diagram illustrating a hardware configuration of a driver monitoring apparatus according to Embodiment (3).

FIG. 10 is a block diagram illustrating a hardware configuration of a learning apparatus for creating a classifier that is to be stored in a classifier storage portion in a driver monitoring apparatus according to Embodiment (3).

FIG. 11 is a flowchart illustrating a learning processing operation performed by a learning control unit in a learning apparatus.

FIG. 12 is a flowchart illustrating a gripping determination processing operation performed by a control unit in a driver monitoring apparatus according to Embodiment (3).

FIG. 13 is a block diagram illustrating a hardware configuration of a driver monitoring apparatus according to Embodiment (4).

### DETAILED DESCRIPTION

Hereinafter, embodiments of a driver monitoring apparatus and a driver monitoring method will be described based on the drawings. Note that the following embodiments are specific examples of the present invention and are technically limited in various ways. However, the scope of the present invention is not limited to these embodiments unless it is particularly stated in the following description that the present invention is limited.

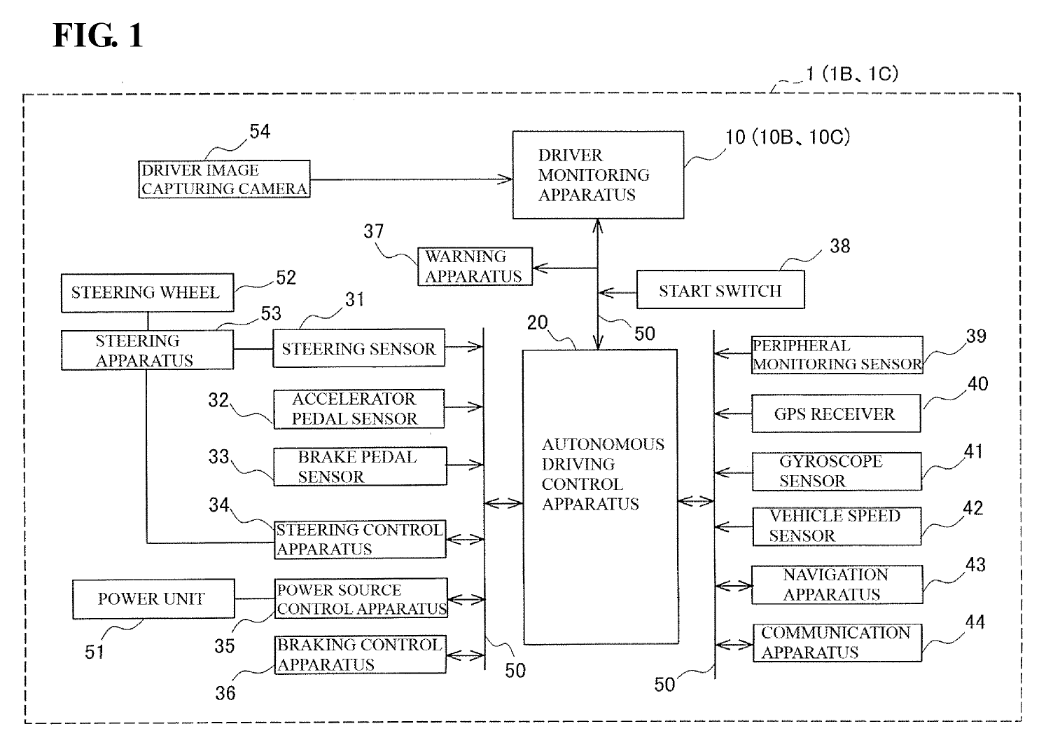

FIG. 1 is a block diagram showing a configuration of essential parts of an autonomous driving system that includes a driver monitoring apparatus according to Embodiment (1).

An autonomous driving system 1 includes a driver monitoring apparatus 10 and an autonomous driving control apparatus 20. The autonomous driving control apparatus 20 has a configuration for switching between an autonomous driving mode, in which at least part of traveling control that includes acceleration and deceleration, steering, and braking of a vehicle is autonomously performed by the system, and a manual driving mode, in which a driver performs driving operations. In one or more embodiments, the driver refers to a person sitting in the driver seat in a vehicle.

In addition to the driver monitoring apparatus 10 and the autonomous driving control apparatus 20, the autonomous driving system 1 includes sensors, control apparatuses, and the like that are required for various kinds of control in autonomous driving and manual driving, such as a steering sensor 31, an accelerator pedal sensor 32, a brake pedal sensor 33, a steering control apparatus 34, a power source control apparatus 35, a braking control apparatus 36, a warning apparatus 37, a start switch 38, a peripheral monitoring sensor 39, a GPS receiver 40, a gyroscope sensor 41, a vehicle speed sensor 42, a navigation apparatus 43, and a communication apparatus 44. These various sensors and control apparatuses are connected to one another via a communication line 50.

The vehicle is also equipped with a power unit 51, which includes power sources such as an engine and a motor, and a steering apparatus 53 that includes a steering wheel 52, which is steered by the driver. A hardware configuration of the driver monitoring apparatus 10 will be described later.

The autonomous driving control apparatus 20 is an apparatus that executes various kinds of control associated with autonomous driving of the vehicle, and is constituted by an electronic control unit that includes a control portion, a storage portion, an input portion, an output portion, and the like, which are not shown in the diagrams. The control portion includes one or more hardware processors, reads out a program stored in the storage portion, and executes various kinds of vehicle control.

The autonomous driving control apparatus 20 is not only connected to the driver monitoring apparatus 10 but also to the steering sensor 31, the accelerator pedal sensor 32, the brake pedal sensor 33, the steering control apparatus 34, the power source control apparatus 35, the braking control apparatus 36, the peripheral monitoring sensor 39, the GPS receiver 40, the gyroscope sensor 41, the vehicle speed sensor 42, the navigation apparatus 43, the communication apparatus 44, and so on. Based on information acquired from these portions, the autonomous driving control apparatus 20 outputs control signals for performing autonomous driving to the control apparatuses, and performs autonomous traveling control (autonomous steering control, autonomous speed adjustment control, autonomous braking control etc.) of the vehicle.

Autonomous driving refers to allowing a vehicle to autonomously travel on a road under the control performed by the autonomous driving control apparatus 20, without a driver sitting in the driver seat and performing driving operations. For example, autonomous driving includes a driving state in which the vehicle is allowed to autonomously travel in accordance with a preset route to a destination, a travel route that is automatically generated based on a situation outside the vehicle and map information, or the like. The autonomous driving control apparatus 20 ends (cancels) autonomous driving if predetermined conditions for canceling autonomous driving are satisfied. For example, the autonomous driving control apparatus 20 ends autonomous driving if it is determined that the vehicle that is subjected to autonomous driving has arrived at a predetermined end point of autonomous driving. The autonomous driving control apparatus 20 may also perform control to end autonomous driving if the driver performs an autonomous driving canceling operation (e.g. an operation to an autonomous driving cancel button, an operation to a steering wheel, an accelerator, or a brake made by the driver etc.). Manual driving refers to driving in which the driver performs driving operations to cause the vehicle to travel.

The steering sensor 31 is a sensor for detecting the amount of steering performed with the steering wheel 52, is provided on, for example, a steering shaft of the vehicle, and detects the steering torque applied to the steering wheel 52 by the driver or the steering angle of the steering wheel 52. A signal that corresponds to a steering wheel operation performed by the driver detected by the steering sensor 31 is output to the autonomous driving control apparatus 20 and the steering control apparatus 34.

The accelerator pedal sensor 32 is a sensor for detecting the amount by which an accelerator pedal (position of the accelerator pedal) is pressed with a foot, and is provided on, for example, a shaft portion of the accelerator pedal. A signal that corresponds to the amount by which the accelerator pedal is pressed with a foot detected by the accelerator pedal sensor 32 is output to the autonomous driving control apparatus 20 and the power source control apparatus 35.

The brake pedal sensor 33 is a sensor for detecting the amount by which the brake pedal is pressed with a foot (position of the brake pedal) or the operational force (foot pressing force etc.) applied thereon. A signal that corresponds to the amount by which the brake pedal is pressed with a foot or the operational force detected by the brake pedal sensor 33 is output to the autonomous driving control apparatus 20 and the braking control apparatus 36.

The steering control apparatus 34 is an electronic control unit for controlling the steering apparatus (e.g. electric power steering device) 53 of the vehicle. The steering control apparatus 34 controls the steering torque of the vehicle by driving a motor for controlling the steering torque of the vehicle. In the autonomous driving mode, the steering torque is controlled in accordance with a control signal from the autonomous driving control apparatus 20.

The power source control apparatus 35 is an electronic control unit for controlling the power unit 51. The power source control apparatus 35 controls the driving force of the vehicle by controlling, for example, the amounts of fuel and air supplied to the engine, or the amount of electricity supplied to the motor. In the autonomous driving mode, the driving force of the vehicle is controlled in accordance with a control signal from the autonomous driving control apparatus 20.

The braking control apparatus 36 is an electronic control unit for controlling a brake system of the vehicle. The braking control apparatus 36 controls the braking force applied to wheels of the vehicle by adjusting the hydraulic pressure applied to a hydraulic pressure brake system, for example. In the autonomous driving mode, the braking force applied to the wheels is controlled in accordance with a control signal from the autonomous driving control apparatus 20.

The warning apparatus 37 is configured to include an audio output portion for outputting various warnings and directions in the form of sound or voice, a display output portion for displaying various warnings and directions in the form of characters or diagrams, or by lighting a lamp, and so on (all these portions not shown in the diagrams). The warning apparatus 37 operates based on warning instruction signals output from the driver monitoring apparatus 10 and the autonomous driving control apparatus 20.

The start switch 38 is a switch for starting and stopping the power unit 51, and is constituted by an ignition switch for starting the engine, a power switch for starting a traveling motor, and so on. An operation signal from the start switch 38 is input to the driver monitoring apparatus 10 and the autonomous driving control apparatus 20.

The peripheral monitoring sensor 39 is a sensor for detecting a target object that is present around the vehicle. The target object may be, for example, a moving object such as a car, a bicycle, or a person, a marker on a road surface (white line etc.), a guard rail, a median strip, or other structures that may affect travel of the vehicle. The peripheral monitoring sensor 39 includes at least one of a front monitoring camera, a rear monitoring camera, a radar, a LIDER, i.e. a Light Detection and Ranging or Laser Imaging Detection and Ranging, and an ultrasonic sensor. Detection data, i.e. data on a target object detected by the peripheral monitoring sensor 39 is output to the autonomous driving control apparatus 20 and so on. A stereo camera, a monocular camera, or the like may be employed as the front monitoring camera and the rear monitoring camera. The radar detects the position, direction, distance, and the like of a target object by transmitting radio waves, such as millimeter waves, to the periphery of the vehicle, and receiving radio waves reflected off a target object that is present around the vehicle. The LIDER detects the position, direction, distance, and the like of a target object by transmitting a laser beam to the periphery of the vehicle and receiving a light beam reflected off a target object that is present around the vehicle.

The GPS receiver 40 is an apparatus that performs processing (GPS navigation) to receive a GPS signal from an artificial satellite via an antenna (not shown) and identify the vehicle position based on the received GPS signal. Information regarding the vehicle position identified by the GPS receiver 40 is output to the autonomous driving control apparatus 20, the navigation apparatus 43, and so on.

The gyroscope sensor 41 is a sensor for detecting the rotational angular speed (yaw rate) of the vehicle. A rotational angular speed signal detected by the gyroscope sensor 41 is output to the autonomous driving control apparatus 20, the navigation apparatus 43, and so on.

The vehicle speed sensor 42 is a sensor for detecting the vehicle speed, and is constituted by, for example, a wheel speed sensor that is provided on a wheel, a drive shaft, or the like, and detects the rotational speed of the vehicle. The vehicle speed signal detected by the vehicle speed sensor 42 is output to the autonomous driving control apparatus 20, the navigation apparatus 43, and so on.

Based on information regarding the vehicle position measured by the GPS receiver 40 or the like, and map information in a map database (not shown), the navigation apparatus 43 identifies the road and traffic lane on which the vehicle is traveling, calculates a route from the current vehicle position to a destination and the like, displays this route on a display portion (not shown), and provides audio output for route guidance or the like from an audio output portion (not shown). The vehicle position information, information regarding the road being traveled, scheduled traveling route information, and the like that are obtained by the navigation apparatus 43 are output to the autonomous driving control apparatus 20. The scheduled traveling route information also includes information associated with autonomous driving switching control, such as a start point and an end point of an autonomous driving zone, and an autonomous driving start notification point and an autonomous driving end (cancellation) notification point. The navigation apparatus 43 is configured to include a control portion, a display portion, an audio output portion, an operation portion, and a map data storage portion, and so on, which are not shown in the diagrams.

The communication apparatus 44 is an apparatus for acquiring various kinds of information via a wireless communication network (e.g. a communication network such as a cellular phone network, VICS (registered trademark), or DSRC (registered trademark). The communication apparatus 44 may also include an inter-vehicle communication function or a road-vehicle communication function. For example, road environment information regarding a course of the vehicle (traffic lane restriction information etc.) can be acquired through road-vehicle communication with a road-side transceiver (e.g. light beacon, ITS spot (registered trademark)) or the like that is provided on a road side. Also, information regarding other vehicles (position information, information regarding traveling control etc.), road environment information detected by other vehicles, and so on can be acquired through inter-vehicle communication.

An driver image capturing camera (image capturing portion) 54 is an apparatus for capturing an image of the driver sitting in the driver seat, and is configured to include a lens unit, an image sensor portion, a light radiation portion, an interface portion, a control portion for controlling these portions, and so on, which are not shown in the diagram. The image sensor portion is configured to include an image sensor such as a CCD or a CMOS, a filter, a microlens, and so on. The light radiation portion includes a light emitting element such as an LED, and may also use an infrared LED or the like so as to be able to capture an image of the state of the driver day and night. The control portion is configured to include a CPU, a memory, an image processing circuit, and so on, for example. The control portion controls the image sensor portion and the light radiation portion to radiate light (e.g. near infrared light etc.) from the light radiation portion, and performs control to capture an image of reflected light of the radiated light using the image sensor portion.

The number of driver image capturing cameras 54 may be one, or may also be two or more. The driver image capturing camera 54 may also be configured separately (i.e. configured as a separate body) from the driver monitoring apparatus 10, or may also be integrally configured (i.e. configured as an integrated body) with the driver monitoring apparatus 10. The driver image capturing camera 54 may be a monocular camera, or may also be a stereo camera.

The position at which the driver image capturing camera 54 is installed in a vehicle cabin is not particularly limited, as long as it is a position at which an image of a field of view, which at least includes the driver's face, a portion from the shoulders to the upper arms, and a portion (e.g. upper portion) of the steering wheel 52 provided on the front side of the driver seat can be captured. For example, the driver image capturing camera 54 can be installed on the steering wheel 52, a column portion of the steering wheel 52, a meter panel portion, above a dashboard, at a position near a rear-view mirror, or on an A pillar portion or the navigation apparatus 43, for example. Driver image data captured by the driver image capturing camera 54 is output to the driver monitoring apparatus 10.

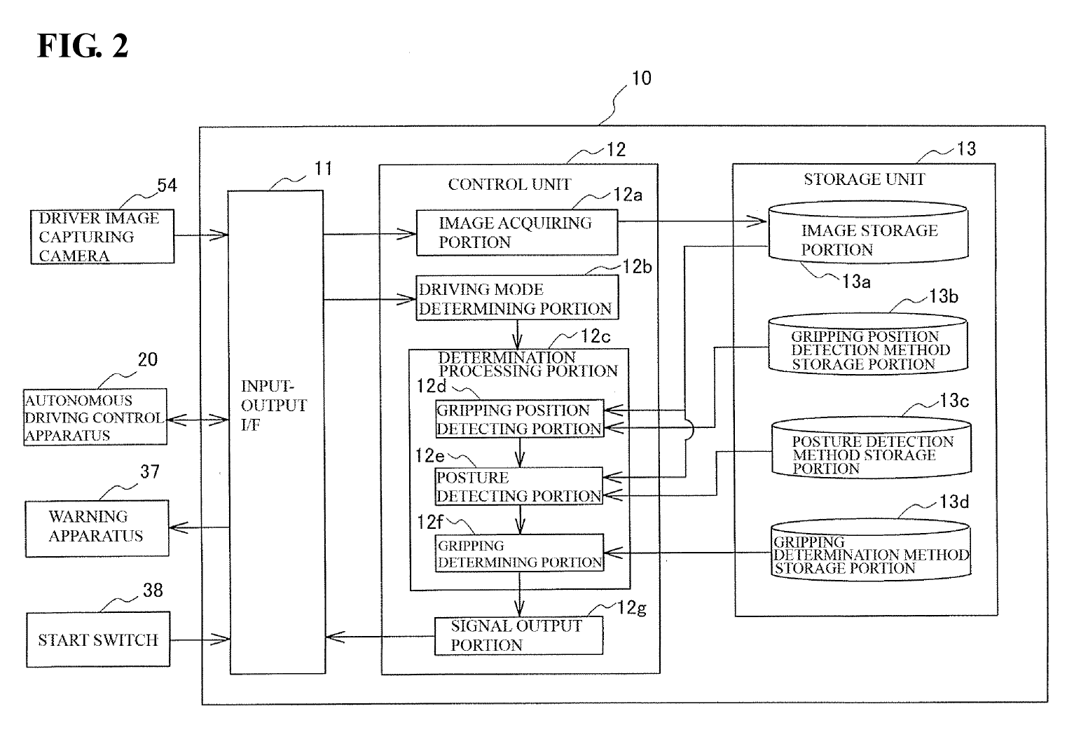

FIG. 2 is a block diagram showing a hardware configuration of the driver monitoring apparatus 10 according to Embodiment (1).

The driver monitoring apparatus 10 is configured to include an input-output interface (I/F) 11, a control unit 12, and a storage unit 13.

The input-output I/F 11 is connected to the driver image capturing camera 54, the autonomous driving control apparatus 20, the warning apparatus 37, the start switch 38, and so on, and is configured to include circuits, connectors, and the like for exchanging signals with these external devices.

The control unit 12 is configured to include an image acquiring portion 12a, a driving mode determining portion 12b, a determination processing portion 12c, and a signal output portion 12g. The control unit 12 is configured to include one or more hardware processors, such as a central processing unit (CPU) and a graphics processing unit (GPU).

The storage unit 13 is configured to include an image storage portion 13a, a gripping position detection method storage portion 13b, a position detection method storage portion 13c, and a gripping determination method storage portion 13d. The storage unit 13 is configured to include one or more memory devices for storing data using semiconductor devices, such as a read only memory (ROM), a random access memory (RAM), a solid-state drive (SSD), a hard disk drive (HDD), a flash memory, and other nonvolatile memories and volatile memories.

A driver image acquired by the image acquiring portion 12a is stored in the image storage portion 13a.

A gripping position detection program that is to be executed by a gripping position detecting portion 12d in the control unit 12, data required to execute this program, and the like are stored in the gripping position detection method storage portion 13b.

A position detection program for detecting the position of a shoulder and arm of the driver that is to be executed by a position detecting portion 12e in the control unit 12, data required to execute this program, and the like are stored in the position detection method storage portion 13c.

A gripping determination program that is to be executed by a gripping determining portion 12f in the control unit 12, data required to execute this program, and the like are stored in the gripping determination method storage portion 13d. For example, a gripping determination table that indicates a correspondence relationship between a gripping position on the steering wheel 52 and the position (orientation and angle) of a shoulder and arm of the driver may also be stored.

The control unit 12 is an apparatus that cooperates with the storage unit 13 to perform, for example, processing to store various pieces of data in the storage unit 13, and perform processing to read out various pieces of data and programs stored in the storage unit 13 and execute these programs.

The image acquiring portion 12a, which is included in the control unit 12, executes processing to acquire the driver image acquired by the driver image capturing camera 54, and performs processing to store the acquired driver image in the image storage portion 13a. The driver image may be a still image, or may also be a moving image. The timing of acquiring the driver image is determined so that, for example, the driver image is acquired at predetermined intervals after the start switch 38 has been turned on. The driver image is also acquired if a cancel notification signal for notifying of cancelation of the autonomous driving mode is detected by the driving mode determining portion 12b.

The driving mode determining portion 12b detects, for example, an autonomous driving mode setting signal, an autonomous driving mode cancel notification signal, an autonomous driving mode cancel signal, and so on that are acquired from the autonomous driving control apparatus 20, and executes processing to determine the driving mode, which may be the autonomous driving mode or the manual driving mode, based on these signals. The autonomous driving mode setting signal is a signal that is output after the setting of (switching to) the autonomous driving mode has been completed. The autonomous driving mode cancel notification signal is a signal that is output before the autonomous driving mode is switched to the manual driving mode (if a manual driving operation succeeding zone is entered). The autonomous driving mode cancel signal is a signal that is output after the autonomous driving mode has been canceled and switched to the manual driving mode.

The determination processing portion 12c includes the gripping position detecting portion 12d, the position detecting portion 12e, and the gripping determining portion 12f, and processing of these portions is executed if the autonomous driving mode cancel notification signal is detected by the driving mode determining portion 12b.

If the autonomous driving mode cancel notification signal is detected, the gripping position detecting portion 12d reads out the driver image (e.g. an image that is captured by the driver image capturing camera 54 and stored in the image storage portion 13a after the autonomous driving mode cancel notification signal has been detected) from the image storage portion 13a, processes the driver image, and detects whether or not the steering wheel 52 is being gripped. If the steering wheel 52 is being gripped, the gripping position detecting portion 12d executes processing to detect the gripping positions on the steering wheel 52.

The aforementioned driver image processing includes the following image processing, for example. Initially, edges (outlines) of the steering wheel 52 are extracted through image processing such as edge detection. Next, edges of a shape that intersects the extracted edge of the steering wheel 52 are extracted. If edges of such an intersecting shape are detected, it is determined whether or not the detected edges correspond to fingers, based on the lengths of the edges and the interval therebetween. If it is determined that the edges correspond to the fingers, the positions of the edges that correspond to the fingers are detected as the gripping positions on the steering wheel 52.

Subsequently to the processing in the gripping position detecting portion 12d, the position detecting portion 12e processes the driver image and executes processing to detect the position of a shoulder and arm of the driver.

In the above driver image processing, for example, processing is performed to detect the edges (outlines) of the shoulder and arm of the driver, i.e. the edges of the shoulders to the upper arms and the edges of the forearms, through image processing such as edge detection, and estimate the direction (orientation) and angle (e.g. angle relative to the vertical direction) of each of the detected edges. The position of the shoulder and arm of the driver includes either the direction or angle of at least either the left or right upper arm and forearm.

Subsequently to the processing in the position detecting portion 12e, the gripping determining portion 12f executes processing to determine whether or not the driver whose image has been captured is gripping the steering wheel 52, based on the gripping positions on the steering wheel 52 detected by the gripping position detecting portion 12d and the position of the shoulder and arm of the driver detected by the position detecting portion 12e.

For example, a determination table is read out that is stored in the gripping determination method storage portion 13d and indicates a relationship between each gripping position on the steering wheel 52 and the corresponding position (orientation and angle) of the shoulder and arm of the driver, and the detected gripping positions on the steering wheel 52 and position of the shoulder and arm of the driver are substituted into the determination table to determine whether or not conditions under which the steering wheel 52 is gripped are met.

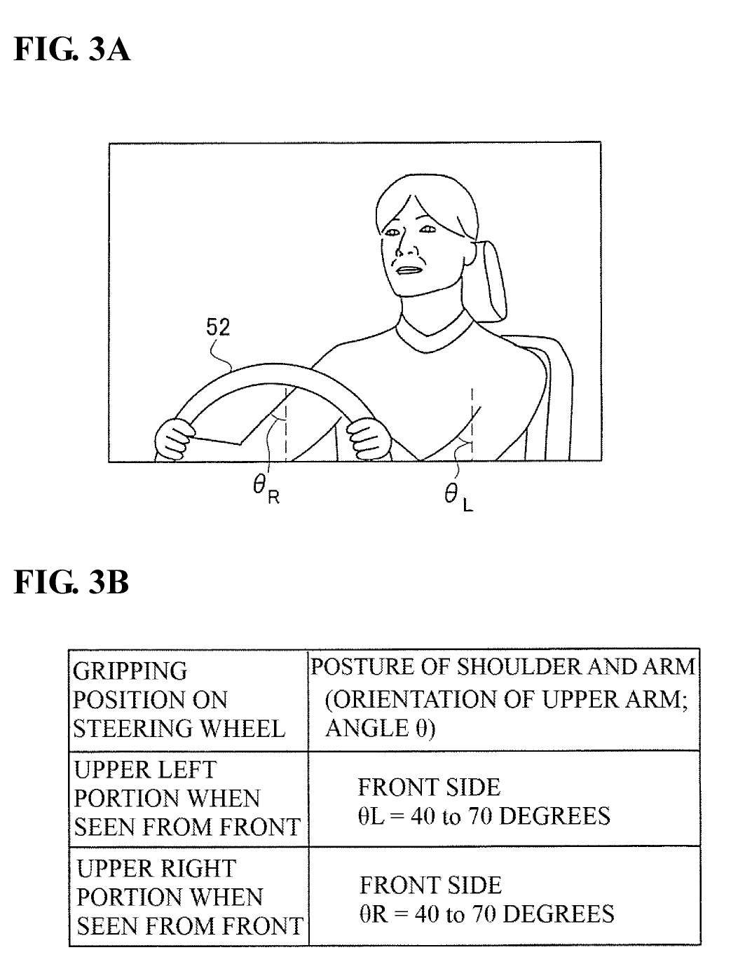

FIG. 3A shows an example of a driver image captured by the driver image capturing camera 54, and FIG. 3B shows an example of the determination table that is stored in the gripping determination method storage portion 13d.

The driver image shown in FIG. 3A indicates a state (appropriate gripped state) where the driver is gripping the steering wheel 52 at two positions, namely upper left and right positions. In the determination table shown in FIG. 3B, position conditions, each of which corresponds to a gripping position on the steering wheel 52 and includes the orientation and angle of the right arm or the left arm, are provided. In the example shown in FIG. 3B, conditions that the upper left arm of the driver is oriented forward and the angle θ_{L} is in a range from 40 to 70 degrees in the case where a gripping position on the steering wheel 52 corresponds to an upper left portion when seen from the front, and conditions that the upper right arm of the driver is oriented forward and the angle θ_{R} is in a range from 40 to 70 degrees in the case where a gripping position on the steering wheel 52 corresponds to an upper right portion when seen from the front, are provided. Note that the angles (θ_{L}, θ_{R}) of the upper arms that are provided in the determination table may be provided so that appropriate determination can be made, in accordance with conditions such as the position at which the driver image capturing camera 54 is installed, the field of view for capturing the image, the position of the driver in the image, and so on.

If the gripping position on the steering wheel 52 is not detected by the gripping position detecting portion 12d, the signal output portion 12g outputs a signal to cause the warning apparatus (warning portion) 37 to execute warning processing to make the driver grip the steering wheel 52.

The signal output portion 12g also outputs a predetermined signal based on the determination result obtained by the gripping determining portion 12f. For example, if the determination result obtained by the gripping determining portion 12f indicates that the driver is gripping the steering wheel 52, the signal output portion 12g outputs, to the autonomous driving control apparatus 20, a signal for permitting switching from the autonomous driving mode to the manual driving mode. On the other hand, if the determination result indicates that the driver is not gripping the steering wheel 52, the signal output portion 12g performs processing to output a signal for instructing the warning apparatus 37 to perform warning processing, or to output, to the autonomous driving control apparatus 20, a signal for giving a forcible danger avoidance instruction to the vehicle to force the vehicle to perform danger avoidance (stop or decelerate) through autonomous driving.

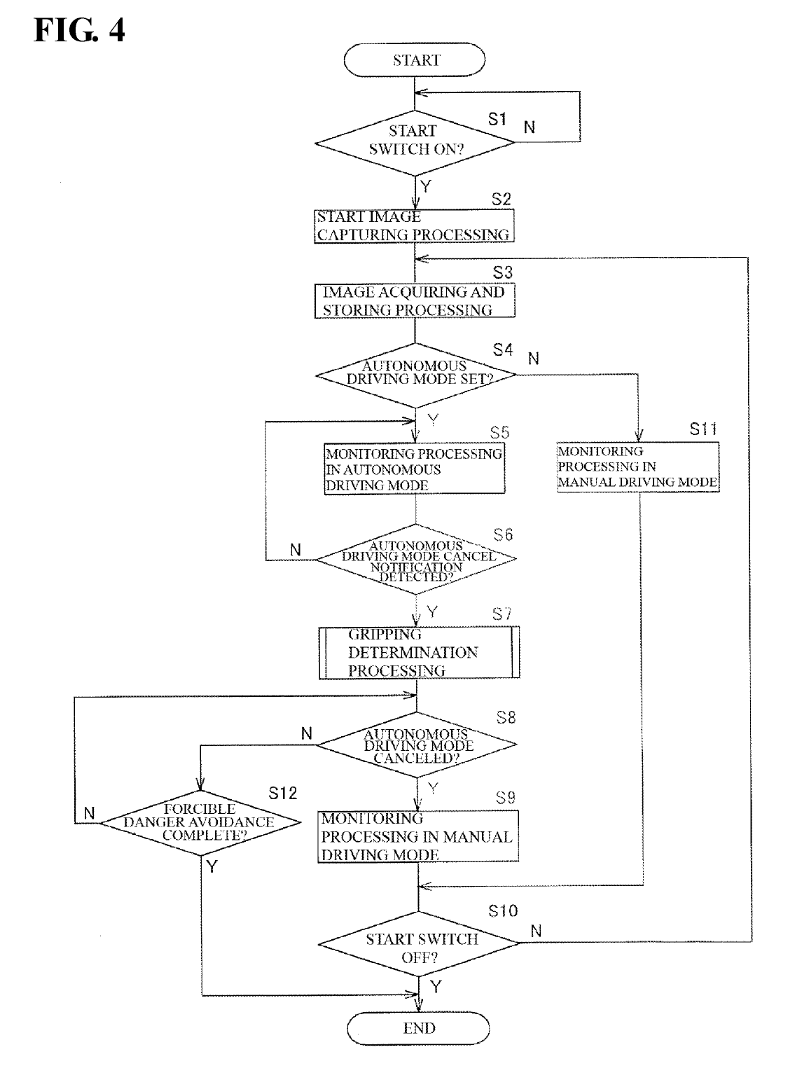

FIG. 4 is a flowchart showing a processing operation performed by the control unit 12 in the driver monitoring apparatus 10 according to Embodiment (1).

Initially, in step S1, whether or not an ON signal from the start switch 38 has been acquired is determined. If it is determined that the ON signal from the start switch 38 has been acquired, the processing proceeds to step S2. In step S2, the driver image capturing camera 54 is started to start processing to capture a driver image. In the next step S3, processing is performed to acquire the driver image captured by the driver image capturing camera 54 and store the acquired image in the image storage portion 13a. Thereafter, the processing proceeds to step S4.

In step S4, whether or not the autonomous driving mode setting signal has been acquired from the autonomous driving control apparatus 20 is determined. If it is determined that the autonomous driving mode setting signal has been acquired, the processing proceeds to step S5. In step S5, driver monitoring processing in the autonomous driving mode is performed. For example, processing is performed to capture an image of the driver during autonomous driving using the driver image capturing camera 54 and analyze the captured driver image to monitor the state of the driver. Thereafter, the processing proceeds to step S6.

In step S6, whether or not the autonomous driving mode cancel notification signal (signal for notifying of switching to the manual driving mode) has been acquired is determined. If it is determined that the autonomous driving mode cancel notification signal has not been acquired (i.e. in the autonomous driving mode), the processing returns to step S5, and the driver monitoring processing in the autonomous driving mode is continued. On the other hand, if it is determined in step S6 that the autonomous driving mode cancel notification signal has been acquired, the processing proceeds to step S7.

In step S7, processing is performed to determine whether or not the driver whose image has been acquired is gripping the steering wheel 52, based on the driver image captured by the driver image capturing camera 54. Thereafter, the processing proceeds to step S8. The details of the gripping determination processing in the step S7 will be described later.

In step S8, whether or not the autonomous driving mode cancel signal has been acquired is determined. If it is determined that the autonomous driving mode cancel signal has been acquired, the processing proceeds to step S9. In step S9, driver monitoring processing in the manual driving mode is performed. For example, processing is performed to capture an image of the driver during manual driving using the driver image capturing camera 54 and analyze the captured driver image to monitor the state of the driver. Thereafter, the processing proceeds to step S10.

In step S10, whether or not an OFF signal from the start switch 38 has been acquired is determined. If it is determined that the OFF signal has been acquired, the processing then ends. On the other hand, if it is determined that the OFF signal has not been acquired, the processing returns to step S3.

If it is determined in step S4 that the autonomous driving mode setting signal has not been acquired, the processing proceeds to step S11, and the driver monitoring processing in the manual driving mode is performed.

If it is determined in step S8 that the autonomous driving mode cancel signal has not been acquired, the processing proceeds to step S12. In step S12, whether or not a signal indicating completion of forcible danger avoidance through autonomous driving has been acquired is determined. If it is determined that the signal indicating completion of forcible danger avoidance has been acquired, the processing then ends. On the other hand, if it is determined that the signal indicating completion of forcible danger avoidance has not been acquired, the processing returns to step S8.

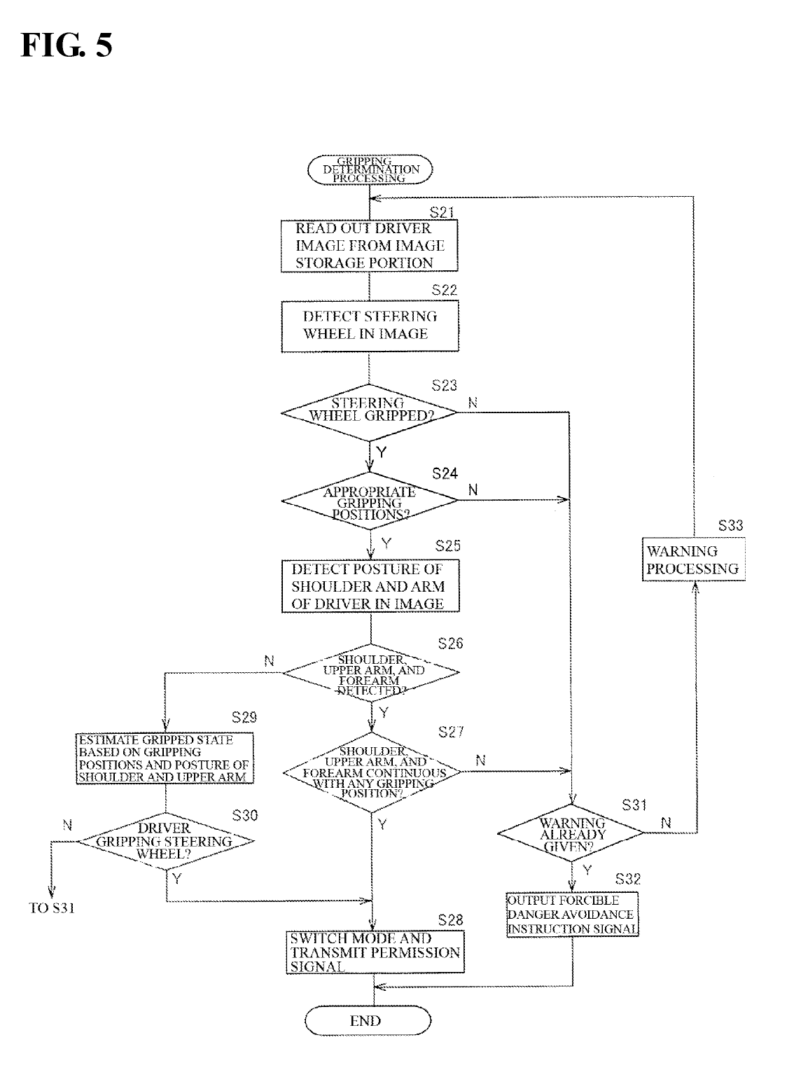

FIG. 5 is a flowchart showing a gripping determination processing operation performed by the control unit 12 in the driver monitoring apparatus 10 according to Embodiment (1). Note that this processing operation indicates processing corresponding to step S7 in FIG. 4, and is executed if an autonomous driving mode cancel notification is detected in step S6.

If the autonomous driving mode cancel notification signal is detected in step S6 in FIG. 4, the processing proceeds to step S21 in the gripping determination processing.

In step S21, the driver image stored in the image storage portion 13a is read out, and the processing proceeds to step S22. The driver image read out from the image storage portion 13a is, for example, the driver image that is captured by the driver image capturing camera 54 and is stored in the image storage portion 13a after the autonomous driving mode cancel notification signal has been acquired. In this description, the driver image is an image obtained by capturing an image of a field of view that includes at least a portion from each shoulder to upper arm of the driver and a portion (e.g. substantially upper half) of the steering wheel 52.

In step S22, image processing for the read driver image starts, and processing is performed to detect the steering wheel 52 in the driver image. Then, the processing proceeds to step S23. For example, edges (outlines) of the steering wheel are extracted through image processing such as edge detection.

In step S23, it is determined whether or not the steering wheel 52 is being gripped. For example, shapes that intersect the above-extracted edges of the steering wheel 52 are extracted, the lengths of the edges of the intersecting shape, the distance therebetween, and the like are detected, and whether or not the intersecting shapes indicate the hands of a person is determined, based on the shape of the edges. A state where the steering wheel 52 is being gripped also includes a state where the hands are touching the steering wheel 52, in addition to a state where the hands are gripping the steering wheel 52.

If it is determined in step S23 that the steering wheel 52 is being gripped, the processing proceeds to step S24. In step S24, whether or not the gripping positions on the steering wheel 52 are appropriate is determined. The cases where the gripping positions on the steering wheel 52 are appropriate include, for example, a case where two gripping positions are detected on a steering wheel portion extracted from the driver image, but are not limited thereto. Also, processing in step S24 may be omitted.

If it is determined in step S24 that the gripping positions on the steering wheel 52 are appropriate, the processing proceeds to step S25. In step S25, processing is performed to detect the position of a shoulder and arm of the driver in the driver image. For example, the edges (outlines) of the shoulder and arm of the driver, i.e. an edge of at least either the left or right shoulder to upper arm and an edge of the corresponding forearm are detected through image processing such as edge detection, and processing is performed to estimate the direction and angle of each of the detected edges.

In the next step S26, it is determined whether or not at least either the left or right shoulder, upper arm, and forearm of the driver (from a shoulder to a hand of the driver) have been detected. If it is determined that these parts have been detected, the processing proceeds to step S27. In step S27, whether or not the above-detected shoulder, upper arm, and forearm are continuous with any gripping position (hand position) on the steering wheel 52 is determined based on the image processing result.

If it is determined in step S27 that these parts are continuous with any gripping position, the processing proceeds to step S28. In step S28, processing is performed to output, to the autonomous driving control apparatus 20, a signal for permitting switching from the autonomous driving mode to the manual driving mode. Thereafter, this processing operation ends, and the processing proceeds to step S8 in FIG. 4.

On the other hand, if it is determined in step S26 that any shoulder, upper arm, and forearm of the driver have not been detected, i.e. at least either the left or right shoulder to upper arm of the driver have not been detected, the processing proceeds to step S29. In step S29, processing is performed to substitute the gripping positions on the steering wheel 52 and the position of the shoulder and the upper arm of the driver into the gripping determination table that is read out from the gripping determination method storage portion 13d, and estimate the state of the steering wheel 52 that is gripped by the driver. Thereafter, the processing proceeds to step S30. In step S30, whether or not the driver is gripping the steering wheel 52 is determined. If it is determined that the driver is gripping the steering wheel 52, the processing proceeds to step S28.

On the other hand, if it is determined in step S23 that the steering wheel 52 is not being gripped, if it is determined in step S24 that the gripping position on the steering wheel 52 is not appropriate, e.g. there is only one gripping position, if it is determined in step S27 that the shoulder, upper arm, and forearm of the driver are not continuous with any gripping position on the steering wheel 52, or if it is determined in step S30 that the driver is not gripping the steering wheel 52, the processing proceeds to step S31.

In step S31, whether or not a warning for making the driver grip the steering wheel 52 in an appropriate position has already been given is determined. If it is determined that the warning has already been given, the processing proceeds to step S32. In step S32, processing is performed to output a forcible danger avoidance instruction signal to the autonomous driving control apparatus 20. Thereafter, this processing ends, and the processing proceeds to step S8 in FIG. 4.

On the other hand, if it is determined in step S31 that the warning has not been given (no warning has been given), the processing proceeds to step S33. In step S33, a signal for causing the warning apparatus 37 to execute warning processing to make the driver grip the steering wheel 52 in an appropriate position is output, and thereafter, the processing returns to step S21.

With the driver monitoring apparatus 10 according to Embodiment (1) described above, if the autonomous driving mode in which autonomous travel is controlled by the autonomous driving control apparatus 20 is switched to the manual driving mode in which the driver steers the vehicle, the driver image captured by the driver image capturing camera 54 is processed to detect the gripping positions on the steering wheel 52 and the position of a shoulder and arm of the driver. Then, whether or not the steering wheel 52 is being gripped by the driver's hand is determined based on the relationship between the detected gripping positions on the steering wheel 52 and the position of the shoulder and arm of the driver. Accordingly, a clear distinction can be made from a state where a passenger other than the driver is gripping the steering wheel 52, and it can be accurately detected whether or not the original driver sitting in the driver seat is gripping the steering wheel 52.

If no gripping position on the steering wheel 52 is detected by the gripping position detecting portion 12d, or if the gripping positions are not appropriate, warning processing for making the driver grip the steering wheel 52 in an appropriate position (e.g. a position in which the driver grips the steering wheel at two upper positions) is executed. Accordingly, the driver can be prompted to take over steering wheel operations in an appropriate position.

If it is determined that the steering wheel 52 is being gripped by the driver's hand, based on the relationship between the gripping positions on the steering wheel 52 and the position of the shoulders and arms of the driver, a signal for permitting switching from the autonomous driving mode to the manual driving mode is output. Accordingly, the autonomous driving mode can be switched to the manual driving mode in a state where the driver has taken over steering wheel operations, and the safety of the vehicle at the time of this switching can be ensured.

If it is determined that the steering wheel 52 is not being gripped by the driver's hand, a signal for not permitting switching from the autonomous driving mode to the manual driving mode is output. Accordingly, switching to the manual driving mode in a state where the driver has not taken over operating of the steering wheel 52 can be prevented.

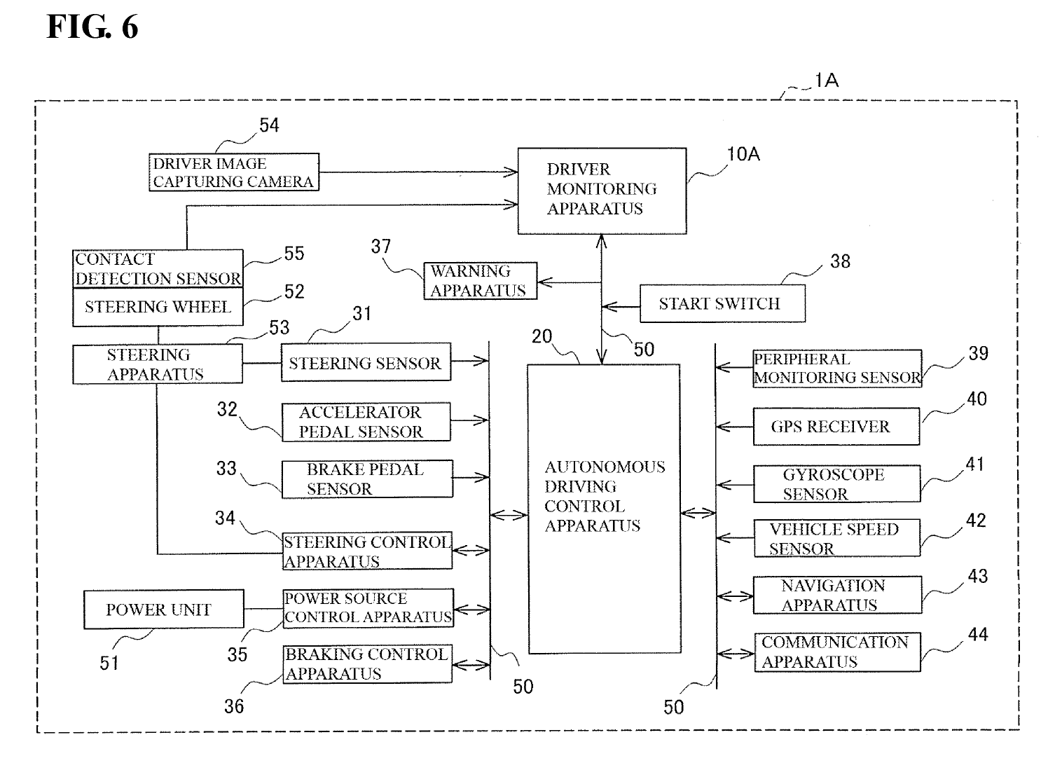

FIG. 6 is a block diagram showing a configuration of essential parts of an autonomous driving system 1A that includes a driver monitoring apparatus 10A according to Embodiment (2). Note that structures that have the same functions as those of the essential parts of the autonomous driving system 1 shown in FIG. 1 are assigned the same numerals, and descriptions thereof are omitted here.

The driver monitoring apparatus 10A according to Embodiment (2) significantly differs from the driver monitoring apparatus 10 according to Embodiment (1) in that a contact signal acquiring portion 12h for acquiring a signal from a contact detection sensor (contact detecting portion) 55, which is provided in the steering wheel 52, is further provided, and processing using the signal acquired from the contact detection sensor 55 is executed.

The contact detection sensor 55 provided in the steering wheel 52 is a sensor capable of detecting hands (particularly, parts such as palms and fingers) that are in contact with the steering wheel 52. For example, the contact detection sensor 55 may be a capacitance sensor, a pressure sensor, or the like, but is not limited thereto.

The capacitance sensor is a sensor that detects a change in the capacitance that occurs between an electrode portion provided in the steering wheel 52 and a hand to detect contact with the steering wheel 52.

The pressure sensor is a sensor that detects pressure applied when the steering wheel 52 is gripped, based on a change in the contact area (value of resistance) between an electrode portion provided in the steering wheel 52 and a detecting portion to detect contact with the steering wheel 52. A plurality of contact detection sensors 55 may also be provided in a circumferential portion or a spoke portion of the steering wheel 52. A signal detected by the contact detection sensor 55 is output to the driver monitoring apparatus 10A.

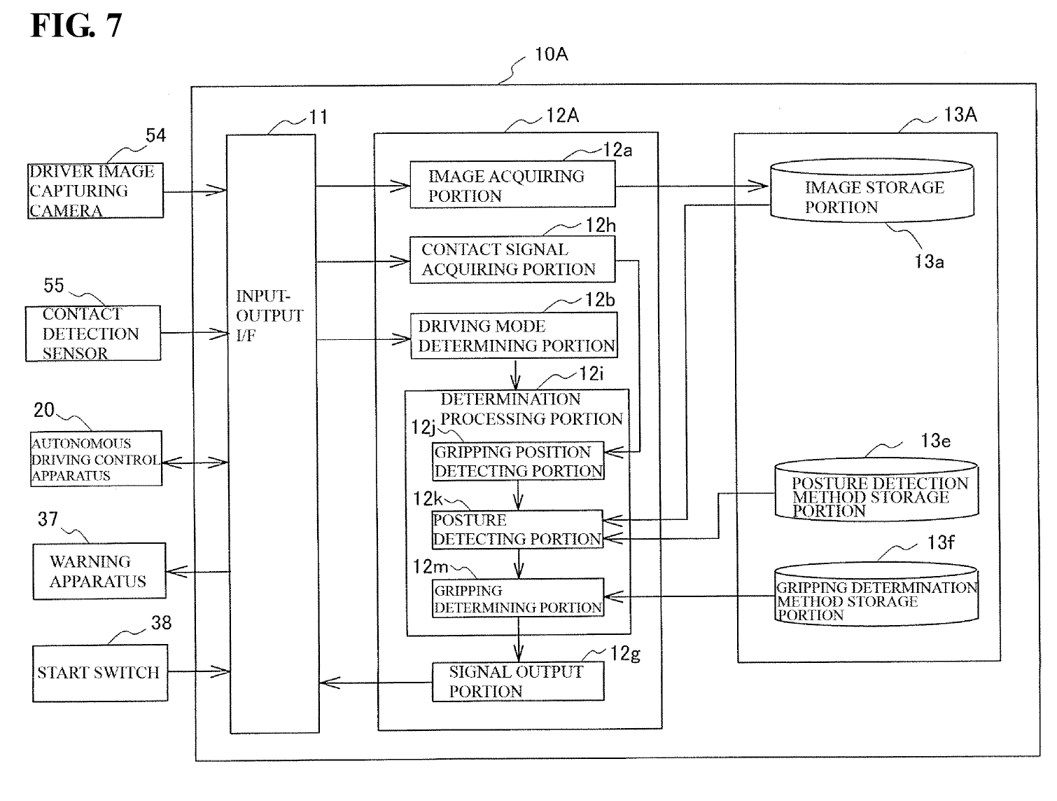

FIG. 7 is a block diagram showing a hardware configuration of the driver monitoring apparatus 10A according to Embodiment (2). Note that structures that have the same functions as those of the essential parts of the hardware configuration of the driver monitoring apparatus 10 shown in FIG. 2 are assigned the same numerals, and descriptions thereof are omitted.

The driver monitoring apparatus 10A is configured to include the input/output interface (I/F) 11, a control unit 12A, and a storage unit 13A.

The input-output I/F 11 is connected to the driver image capturing camera 54, the contact detection sensor 55, the autonomous driving control apparatus 20, the warning apparatus 37, the start switch 38, and so on, and is configured to include circuits, connectors, and the like for exchanging signals with these external devices.

The control unit 12A is configured to include the image acquiring portion 12a, the contact signal acquiring portion 12h, the driving mode determining portion 12b, a determination processing portion 12i, and the signal output portion 12g. The control unit 12A is configured to include one or more hardware processors, such as a CPU and a GPU.

The storage unit 13A is configured to include the image storage portion 13a, a position detection method storage portion 13e, and a gripping determination method storage portion 13f. The storage unit 13A is configured to include one or more memory devices for storing data using semiconductor devices such as a ROM, a RAM, an SSD, an HDD, a flash memory, other nonvolatile memories, and volatile memories.

A driver image (an image captured by the driver image capturing camera 54) acquired by the image acquiring portion 12a is stored in the image storage portion 13a.

A position detection program for detecting the position of a shoulder and arm of the driver that is to be executed by a position detecting portion 12k in the control unit 12A, data required to execute this program, and the like are stored in the position detection method storage portion 13e.

A gripping determination program that is to be executed by a gripping determining portion 12m in the control unit 12A, data required to execute this program, and the like are stored in the gripping determination method storage portion 13f. For example, a gripping determination table that indicates a correspondence relationship between the gripping positions on the steering wheel 52 and the positions (orientations and angles) of a shoulder and arm of the driver may also be stored.

The control unit 12A is configured to cooperate with the storage unit 13A to perform processing to store various pieces of data in the storage unit 13A, read out data and programs stored in the storage unit 13A, and execute these programs.

The contact signal acquiring portion 12h executes processing to acquire a contact signal from the contact detection sensor 55 if an autonomous driving mode cancel notification signal (a signal for noticing switching from the autonomous driving mode to the manual driving mode) is detected by the driving mode determining portion 12b, and sends the acquired contact signal to a gripping position detecting portion 12j.

The determination processing portion 12i includes the gripping position detecting portion 12j, the position detecting portion 12k, and the gripping determining portion 12m, and processing of these portions is executed if the autonomous driving mode cancel notification signal is detected by the driving mode determining portion 12b.

If the autonomous driving mode cancel notification signal is detected, the gripping position detecting portion 12j obtains, from the contact signal acquiring portion 12h, the contact signal detected by the contact detection sensor 55, and executes processing to detect whether or not the steering wheel 52 is being gripped, and also detect gripping positions on the steering wheel 52, based on the contact signal.

Subsequently to the processing in the gripping position detecting portion 12j, the position detecting portion 12k processes the driver image and executes processing to detect the position of a shoulder and arm of the driver.

In the above driver image processing, for example, processing is performed to detect the edges (outlines) of a shoulder and arm of the driver, i.e. the edges of a shoulder to an upper arm and the edges of a forearm included in the image through image processing such as edge detection, and estimate the direction and angle (angle relative to the vertical direction) of each of the detected edges. The position of a shoulder and arm of the driver include either the direction (orientation) or angle of at least either the left or right upper arm and forearm.

Subsequently to the processing in the position detecting portion 12k, the gripping determining portion 12m executes processing to determine whether or not the driver whose image has been captured is gripping the steering wheel 52, based on the gripping positions on the steering wheel 52 detected by the gripping position detecting portion 12j and the position of the shoulder and arm of the driver detected by the position detecting portion 12k.

For example, a gripping determination table is read out that is stored in the gripping determination method storage portion 13f and indicates a relationship between the gripping positions on the steering wheel 52 and the position (orientations and angles) of the shoulders and arms of the driver, and whether or not gripping conditions are met is determined by substituting the detected gripping positions on the steering wheel 52 and the detected position of the shoulder and arm of the driver into the gripping determination table.

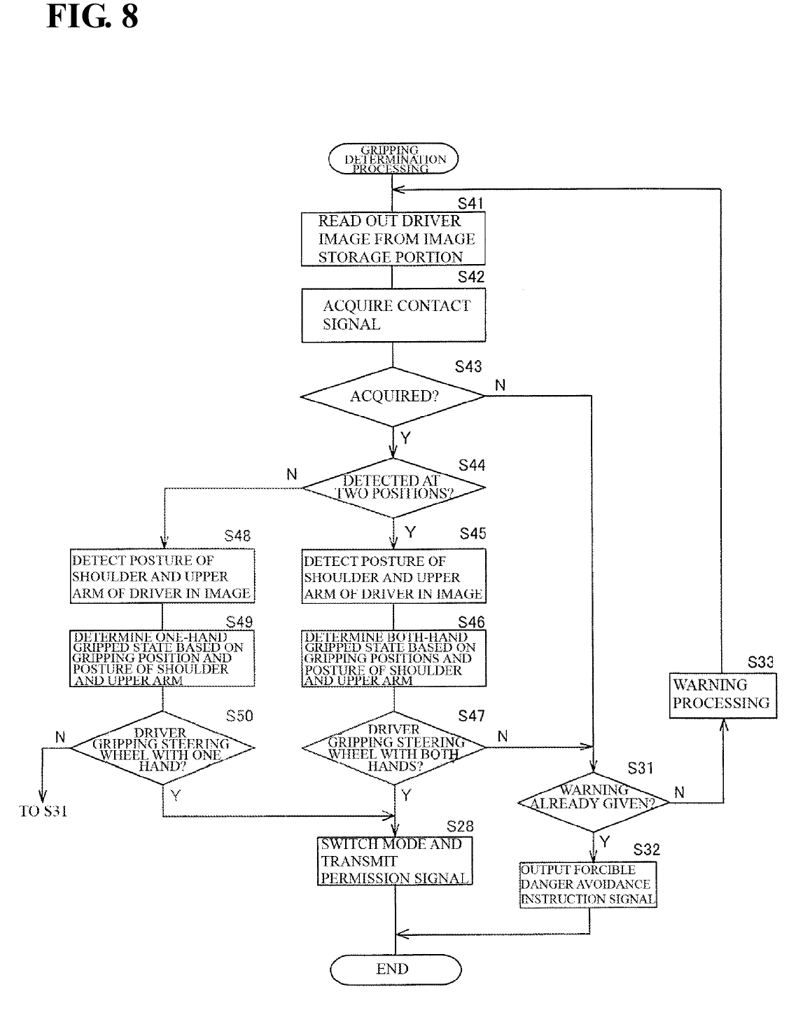

FIG. 8 is a flowchart showing a gripping determination processing operation performed by the control unit 12A in the driver monitoring apparatus 10A according to Embodiment (2). This processing operation indicates processing corresponding to step S7 in FIG. 4, and is executed if an autonomous driving mode cancel notification is detected in step S6. Note that processing operations whose content is the same as those in the gripping determination processing operation shown in FIG. 5 are assigned the same numerals, and descriptions thereof are omitted.

If the autonomous driving mode cancel notification signal is detected in step S6 in FIG. 4, the processing proceeds to step S41 in the gripping determination processing. In step S41, the driver image stored in the image storage portion 13a is read out, and the processing proceeds to step S42. The driver image read out from the image storage portion 13a is, for example, the driver image that is captured by the driver image capturing camera 54 and is stored in the image storage portion 13a after the autonomous driving mode cancel notification signal has been acquired. Note that the driver image is an image obtained by capturing an image of a field of view that at least includes the face and a portion of a shoulder and arm of the driver. The steering wheel 52 may or may not appear in the driver image.

In step S42, processing is performed to acquire the contact signal from the contact detection sensor 55, and the processing proceeds to step S43. In step S43, whether or not the contact signal has been acquired (i.e. whether or not the steering wheel 52 is being gripped) is determined. If it is determined that the contact signal has been acquired (i.e. the steering wheel 52 is being gripped), the processing proceeds to step S44.

In step S44, it is determined whether or not the number of positions at which the contact signal was detected is two. If it is determined that the contact signal is detected at two positions, the processing proceeds to step S45. In step S45, processing is performed to detect the position of a shoulder and upper arm of the driver in the driver image.

For example, the edges (outlines) of a shoulder and arm of the driver, i.e. edges of at least either the left or right shoulder to upper arm are detected through image processing such as edge detection, and processing is performed to detect the direction and angle of each of the detected edges. Thereafter, the processing proceeds to step S46.

In step S46, processing is performed to substitute the gripping positions on the steering wheel 52 and the position of the shoulder and upper arm of the driver into the gripping determination table that is read out from the gripping determination method storage portion 13f, and performs determination regarding a both-hand gripped state of the steering wheel 52 that is gripped by the driver. Thereafter, the processing proceeds to step S47.

In step S47, whether or not the driver is gripping the steering wheel 52 with both hands is determined. If it is determined that the driver is gripping the steering wheel 52 with both hands, the processing proceeds to step S28, and thereafter the gripping determination processing ends.

On the other hand, if it is determined in step S44 that the number of positions at which the contact signal was detected is not two, i.e. is one, the processing proceeds to step S48. In step S48, processing is performed to detect the position of a shoulder and upper arm of the driver in the driver image. Thereafter, the processing proceeds to step S49.

In step S49, processing is performed to substitute the gripping position on the steering wheel 52 and the position of the shoulder and upper arm of the driver into the gripping determination table read out from the gripping determination method storage portion 13f, and perform determination regarding a one-hand gripped state of the steering wheel 52 gripped by the driver. Thereafter, the processing proceeds to step S50.

In step S50, whether or not the driver is gripping the steering wheel 52 with one hand is determined. If it is determined that the driver is gripping the steering wheel 52 with one hand, the processing proceeds to step S28, and thereafter the gripping determination processing ends.

On the other hand, if it is determined in step S43 that the contact signal has not been acquired, or if it is determined in step S47 that the driver is not gripping the steering wheel with both hands, or if it is determined in step S50 that the driver is not gripping the steering wheel with one hand, the processing proceeds to steps S31 to S33.

With the driver monitoring apparatus 10A according to Embodiment (2) if the autonomous driving mode is to be switched to the manual driving mode, a gripping position on the steering wheel 52 is detected based on the contact signal acquired from the contact detection sensor 55, and whether or not the steering wheel 52 is being gripped by both hands or one hand of the driver is determined, based on the detected gripping position on the steering wheel 52 and the position of the shoulder and arm of the driver detected by processing the driver image.

Accordingly, even if the steering wheel 52 does not appear in the driver image, it is possible to distinguish from a state where a passenger other than the driver is gripping the steering wheel 52, and accurately detect whether or not the original driver sitting in the driver seat is gripping the steering wheel 52 with both hands or one hand.

Note that, in the above-described driver monitoring apparatus 10A, a gripping position on the steering wheel 52 is detected based on the contact signal acquired from the contact detection sensor 55. However, in the case where a portion (substantially upper half) of the steering wheel 52 also appears in the driver image, when detecting a gripping position on the steering wheel 52, the gripping position that is detected based on the contact signal acquired from the contact detection sensor 55 may be compared with a gripping position detected by processing the driver image to detect the gripping position on the steering wheel.

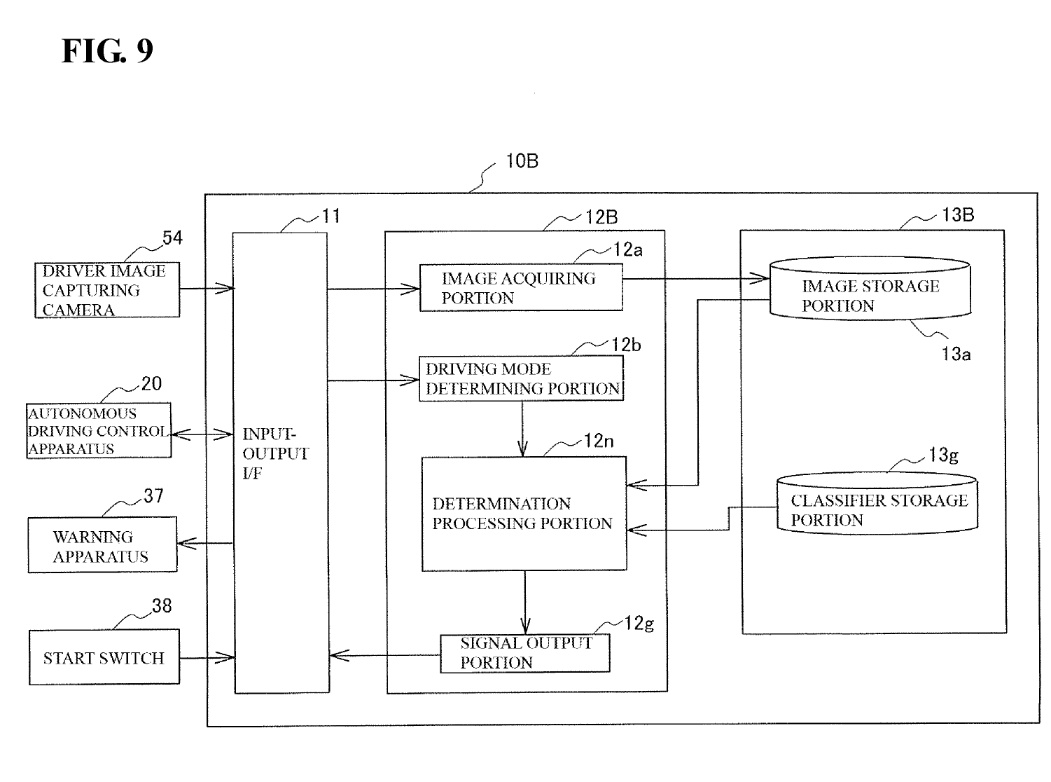

FIG. 9 is a block diagram showing a hardware configuration of a driver monitoring apparatus 10B according to Embodiment (3). Note that structures that have the same functions as those of the essential parts of the hardware configuration of the driver monitoring apparatus 10 shown in FIG. 2 are assigned the same numerals, and descriptions thereof are omitted. Since the configuration of essential parts of an autonomous driving system 1B that includes the driver monitoring apparatus 10B according to Embodiment (3) is substantially the same as that of the autonomous driving system 1 shown in FIG. 1, structures that have the same functions are assigned the same numerals, and descriptions thereof are omitted.

The driver monitoring apparatus 10B according to Embodiment (3) significantly differs from the driver monitoring apparatus 10 according to Embodiment (1) in that processing is executed to determine whether or not a driver who appears in the driver image is gripping the steering wheel 52, using a classifier that is created by training a learning device using, as training data, driver images in which the driver is gripping the steering wheel 52 and driver images in which the driver is not gripping the steering wheel 52.

The driver monitoring apparatus 10B according to Embodiment (3) is configured to include the input/output interface (I/F) 11, a control unit 12B, and a storage unit 13B.

The input-output I/F 11 is connected to the driver image capturing camera 54, the autonomous driving control apparatus 20, the warning apparatus 37, the start switch 38, and so on, and is configured to include circuits, connectors, and the like for exchanging signals with these external devices.

The control unit 12B is configured to include the image acquiring portion 12a, the driving mode determining portion 12b, a determination processing portion 12n, and the signal output portion 12g. The control unit 12B is configured to include one or more hardware processors, such as a CPU and a GPU.

The storage unit 13B is configured to include the image storage portion 13a and a classifier storage portion 13g, and is configured to include one or more memory devices for storing data using semiconductor devices such as a ROM, a RAM, an SSD, an HDD, a flash memory, other nonvolatile memories, and volatile memories.

A driver image (an image captured by the driver image capturing camera 54) acquired by the image acquiring portion 12a is stored in the image storage portion 13a.

A trained classifier for gripping determination is stored in the classifier storage portion 13g. The trained classifier is a learning model that is created as a result of a later-described learning apparatus 60 performing, in advance, learning processing using, as training data, driver images in which the driver is gripping the steering wheel 52 and driver images in which the driver is not gripping the steering wheel 52, and is constituted by a neural network, for example.

The neural network may be a hierarchical neural network, or may also be a convolutional neural network. The number of trained classifiers to be stored in the classifier storage portion 13g may be one, or may also be two or more. A plurality of trained classifiers that correspond to attributes (male, female, physiques etc.) of the driver who appears in the driver images may also be stored.

The trained classifier is constituted by a neural network with which a signal is processed by a plurality of neurons (which are also called units) that are divided by a plurality of layers, which includes an input layer, hidden layers (intermediate layers), and an output layer, and a classification result is output from the output layer.

The input layer is a layer for receiving information to be given to the neural network. For example, the input layer includes units, the number of which corresponds to the number of pixels in a driver image, and information regarding each pixel in a driver image is input to a corresponding neuron.

Neurons in the intermediate layers perform processing to output a value that is obtained by processing, using a transfer function (e.g. step function, sigmoid function etc.), a value obtained by adding a plurality of input values while integrating weights therewith, and further subtracting a threshold from the resultant value, and extract features of a driver image that is input to the input layer. In shallower layers of the intermediate layers, small features (lines etc.) of a driver in the driver image are recognized. In deeper layers (further on the output side), small features are combined, and large features (features in a wider range) of the driver are recognized.

Neurons in the output layer output the result of calculation performed by the neural network. For example, the output layer is constituted by two neurons, and outputs the result of classifying (identifying) whether a state where the steering wheel is being gripped and a state where the steering wheel is not being gripped applies.

The control unit 12B cooperates with the storage unit 13B to execute processing to store various pieces of data in the storage unit 13B, and read out the data, the classifier, and the like stored in the storage unit 13B and execute gripping determination processing using the classifier.

If the autonomous driving mode cancel notification signal is detected by the driving mode determining portion 12b, the determination processing portion 12n reads out the trained classifier from the classifier storage portion 13g and also reads out the driver image from the image storage portion 13a. The determination processing portion 12n then inputs pixel data (pixel values) of the driver image to the input layer of the trained classifier, performs calculation processing of the intermediate layers in the neural network, and performs processing to output, from the output layer, the result of classifying (identifying) whether the driver is in a state of gripping the steering wheel or a state of not gripping the steering wheel.

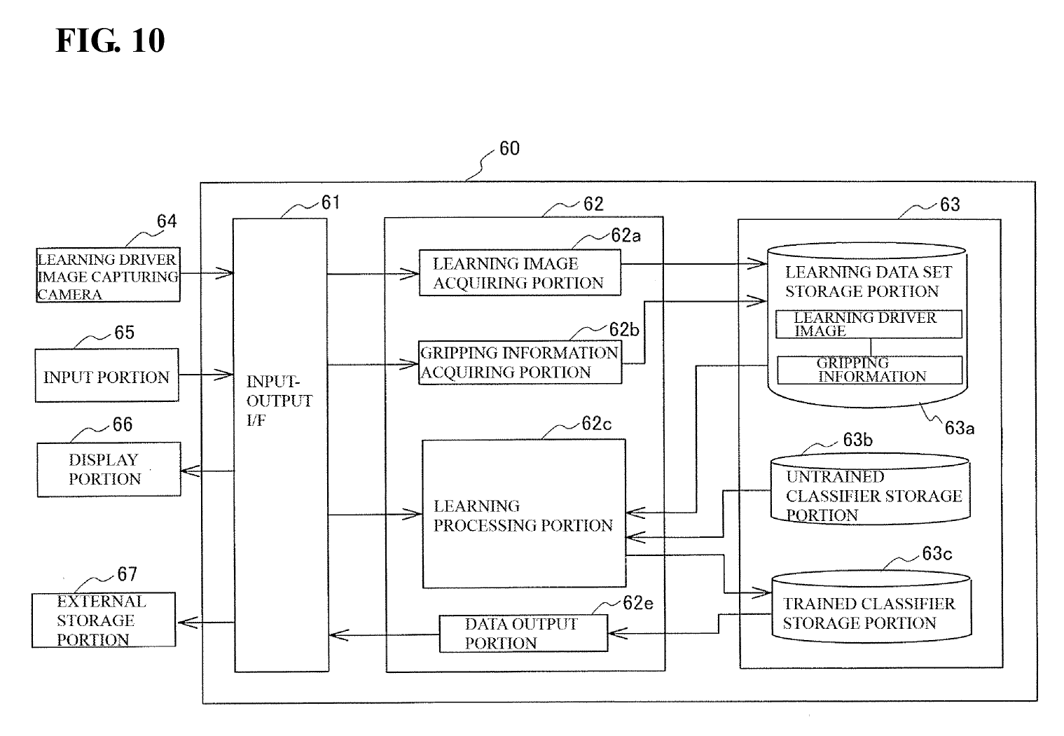

FIG. 10 is a block diagram showing a hardware configuration of the learning apparatus 60 for creating the trained classifier to be stored in the driver monitoring apparatus 10B.

The learning apparatus 60 is constituted by a computer apparatus that includes an input-output interface (I/F) 61, a learning control unit 62, and a learning storage unit 63.

The input-output I/F 61 is connected to a learning driver image capturing camera 64, an input portion 65, a display portion 66, an external storage portion 67, and so on, and is configured to include circuits, connectors, and the like for exchanging signals with these external devices.

The learning driver image capturing camera 64 is, for example, a camera with which a driving simulator apparatus is equipped, and is an apparatus for capturing an image of a driver sitting in a driver seat in the driving simulator apparatus. The field of view captured by the learning driver image capturing camera 64 is set to be the same as the field of view of the driver image capturing camera 54 mounted in the vehicle. The input portion 65 is constituted by an input device such as a keyboard. The display portion 66 is constituted by a display device such as a liquid-crystal display. The external storage portion 67 is an external storage device, and is constituted by an HDD, an SSD, a flash memory, or the like.

The learning control unit 62 is configured to include a learning image acquiring portion 62a, a gripping information acquiring portion 62b, a learning processing portion 62c, and a data output portion 62e, and is configured to include one or more hardware processors such as a CPU and a GPU.

The learning storage unit 63 is configured to include a learning data set storage portion 63a, an untrained classifier storage portion 63b, and a trained classifier storage portion 63c. The learning storage unit 63 is configured to include one or more memory devices for storing data using semiconductor devices such as a ROM, a RAM, an SSD, an HDD, a flash memory, other nonvolatile memories, and volatile memories.

The learning control unit 62 is configured to cooperate with the learning storage unit 63 to perform processing to store various pieces of data (trained classifier etc.) in the learning storage unit 63, as well as read out data and programs (untrained classifier etc.) stored in the learning storage unit 63 and execute these programs.

The learning image acquiring portion 62a performs, for example, processing to acquire learning driver images captured by the learning driver image capturing camera 64, and store the acquired learning driver images in the learning data set storage portion 63a. The learning driver images include images of the driver gripping the steering wheel of the driving simulator apparatus and images of drivers not gripping the steering wheel.

The gripping information acquiring portion 62b performs, for example, processing to acquire steering wheel gripping information (correct answer data for the gripped state), which serves as training data that is to be associated with each learning driver image acquired by the learning image acquiring portion 62a, and store, in the learning data set storage portion 63a, the acquired steering wheel gripping information in association with the corresponding learning driver image. The steering wheel gripping information includes correct answer data regarding whether or not the steering wheel is being gripped. The steering wheel gripping information is input by a designer via the input portion 65.

The learning processing portion 62c performs, for example, processing to create a trained classifier by performing learning processing using an untrained classifier, such as an untrained neural network, and a learning data set (learning driver images and steering wheel gripping information), and store the created trained classifier in the trained classifier storage portion 63c.

The data output portion 62e performs, for example, processing to output the trained classifier stored in the trained classifier storage portion 63c, to the external storage portion 67.

The learning data set storage portion 63a stores the learning driver images and the steering wheel gripping information, which serves as the training data (correct answer data) therefor, in association with each other.

The untrained classifier storage portion 63b stores information regarding the untrained classifier, such as a program of an untrained neural network.

The trained classifier storage portion 63c stores information regarding the trained classifier, such as a program of a trained neural network.

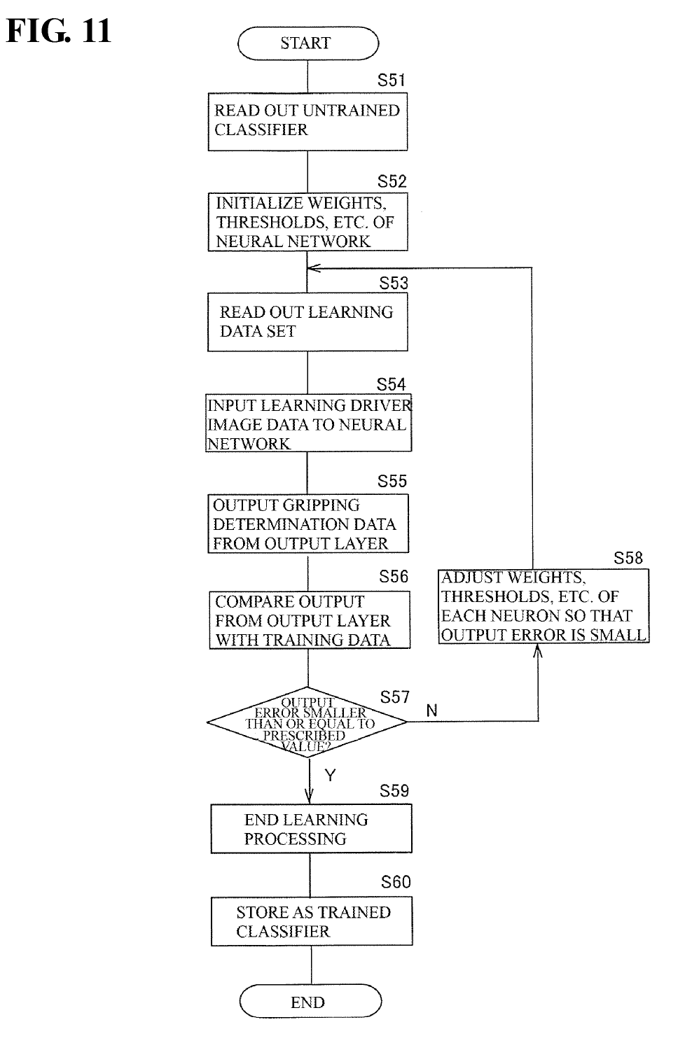

FIG. 11 is a flowchart showing a learning processing operation performed by the learning control unit 62 in the learning apparatus 60.

Initially, in step S51, an untrained classifier is read out from the untrained classifier storage portion 63b. In the next step S52, constants such as the weights, thresholds, and the like of the neural network that constitute the untrained classifier are initialized. The processing then proceeds to step S53.

In step S53, the learning data set (a learning driver image and steering wheel gripping information) is read out from the learning data set storage portion 63a. In the next step S54, pixel data (pixel values) that constitutes the read learning driver image is input to the input layer of the untrained neural network. The processing then proceeds to step S55.

In step S55, gripping determination data is output from the output layer of the untrained neural network. In the next step S56, the output gripping determination data is compared with the steering wheel gripping information, which serves as the training data. The processing then proceeds to step S57.

In step S57, whether or not an output error is smaller than or equal to a prescribed value is determined. If it is determined that the output error is not smaller than or equal to the prescribed value, the processing proceeds to step S58. In step S58, properties (weights, thresholds etc.) of the neurons in the intermediate layers that constitute the neural network are adjusted so that the output error is smaller than or equal to the prescribed value. Thereafter, the processing returns to step S53, and the learning processing is continued. Backpropagation may also be used in step S58.

On the other hand, if it is determined in step S57 that the output error is smaller than or equal to the prescribed value, the processing proceeds to step S59, the learning processing ends, and the processing proceeds to step S60. In step S60, the trained neural network is stored as a trained classifier in the trained classifier storage portion 63c. Thereafter, the processing ends.

The trained classifier stored in the trained classifier storage portion 63c can be output to the external storage portion 67 by the data output portion 62e. The trained classifier stored in the external storage portion 67 is stored in the classifier storage portion 13g in the driver monitoring apparatus 10B.

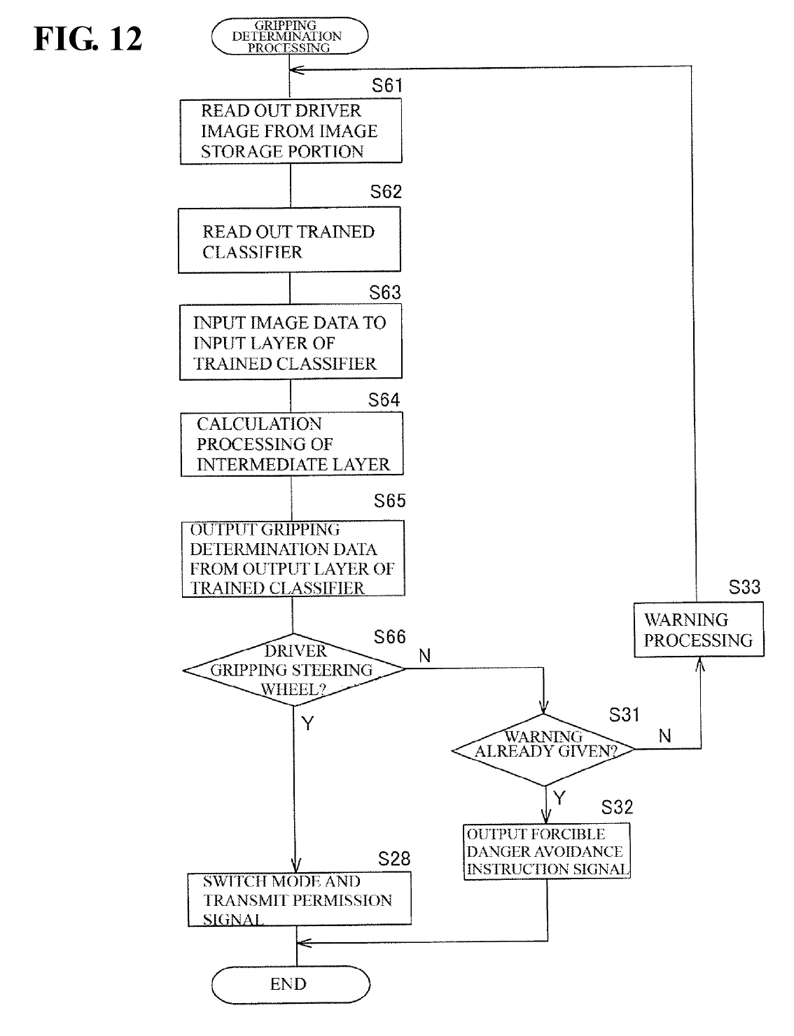

FIG. 12 is a flowchart showing a gripping determination processing operation performed by the control unit 12B in the driver monitoring apparatus 10B according to Embodiment (3). Note that this processing operation indicates processing corresponding to step S7 in FIG. 4, and is executed if an autonomous driving mode cancel notification is detected in step S6. Note that processing operations whose content is the same as those in the gripping determination processing operation shown in FIG. 5 are assigned the same numerals, and descriptions thereof are omitted.

If the autonomous driving mode cancel notification signal is detected in step S6 in FIG. 4, the processing proceeds to step S61 in the gripping determination processing. In step S61, the driver image stored in the image storage portion 13a is read out, and the processing proceeds to step S62. The driver image read out from the image storage portion 13a is, for example, the driver image that is captured by the driver image capturing camera 54 and is stored in the image storage portion 13a after the autonomous driving mode cancel notification signal has been acquired.

In step S62, the trained classifier is read out from the classifier storage portion 13g, and the processing then proceeds to step S63 Here, it is assumed that the trained classifier is constituted by a neural network that includes an input layer, hidden layers (intermediate layers), and an output layer. In step S63, pixel values of the driver image are input to the input layer of the read trained classifier, and the processing then proceeds to step S64.

In step S64, calculation processing of the intermediate layers in the trained classifier is performed, and thereafter, the processing proceeds to step S65.

In step S65, the gripping determination data is output from the output layer of the trained classifier. In the next step S66, it is determined whether or not the driver is gripping the steering wheel 52, based on the output gripping determination data.

If it is determined in step S66 that the driver is gripping the steering wheel 52, the processing proceeds to step S28, and a signal for permitting switching from the autonomous driving mode to the manual driving mode is output to the autonomous driving control apparatus 20. Thereafter, the gripping determination processing ends, and the processing proceeds to step S8 in FIG. 4.

On the other hand, if it is determined in step S66 that the driver is not gripping the steering wheel 52, the processing proceeds to steps S31 to S33.

With the driver monitoring apparatus 10B according to Embodiment (3), if the autonomous driving mode is to be switched to the manual driving mode under the control of the autonomous driving control apparatus 20, driver image data is input to the input layer of the trained classifier, and determination data regarding whether or not the steering wheel 52 is being gripped by the driver's hand is output from the output layer.

Accordingly, a distinction can be made from a state where a passenger other than the driver is gripping the steering wheel 52, by using the trained classifier in the processing in the determination processing portion 12n. Thus, whether or not the original driver sitting in the driver seat is gripping the steering wheel 52 can be accurately detected.

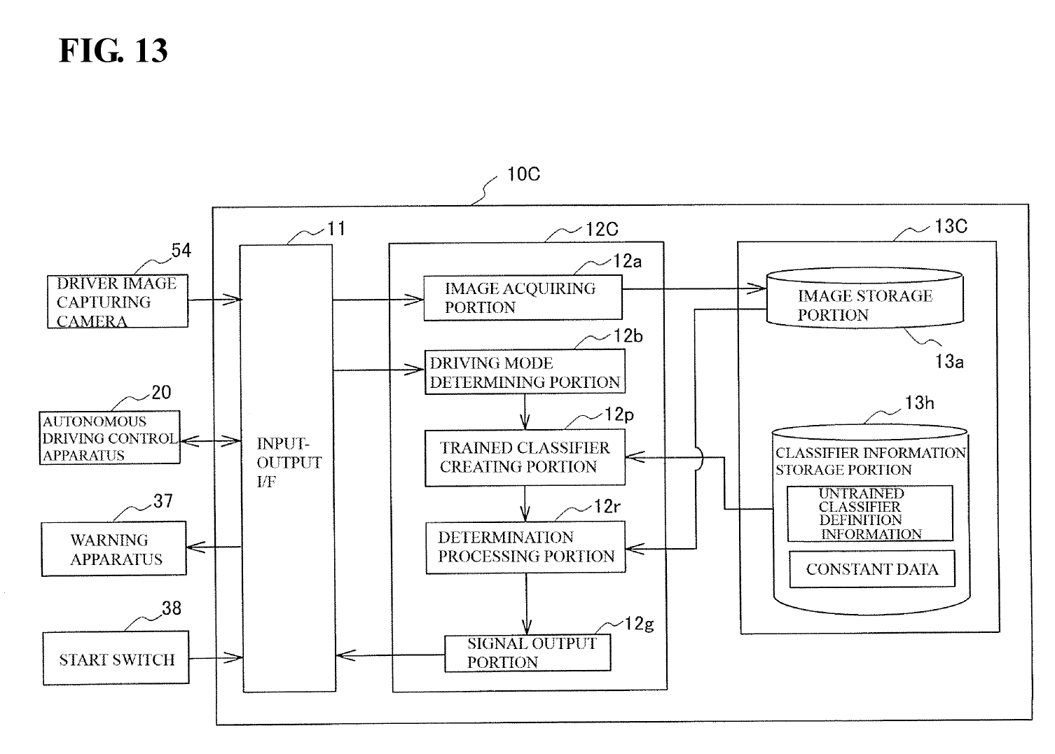

FIG. 13 is a block diagram showing a hardware configuration of a driver monitoring apparatus 10C according to Embodiment (4). Since the configuration of essential parts of an autonomous driving system 1C that includes the driver monitoring apparatus 10C according to Embodiment (4) is substantially the same as that of the autonomous driving system 1 shown in FIG. 1, structures that have the same functionalities are assigned the same numerals, and descriptions thereof are omitted.

The driver monitoring apparatus 10C according to Embodiment (4) is a modification of the driver monitoring apparatus 10B according to Embodiment (3), and has a configuration in which a trained classifier creating portion 12p and a determination processing portion 12r in a control unit 12C, and a classifier information storage portion 13h in a storage unit 13C are different.

The driver monitoring apparatus 10C according to Embodiment (4) is configured to include the input/output interface (I/F) 11, the control unit 12C, and the storage unit 13C.

The control unit 12C is configured to include the image acquiring portion 12a, the driving mode determining portion 12b, the trained classifier creating portion 12p, the determination processing portion 12r, and the signal output portion 12g.

The storage unit 13C is configured to include the image storage portion 13a and the classifier information storage portion 13h.

The classifier information storage portion 13h stores definition information regarding an untrained classifier that includes the number of layers in the neural network, the number of neurons in each layer, and a transfer function (e.g. step function, sigmoid function etc.), and constant data that includes weights and thresholds for neurons in each layer that are obtained in advance through learning processing. The definition information regarding an untrained classifier may be for one classifier, or may be for two or more classifiers. As for the constant data, a plurality of sets of constant data that correspond to attributes (male, female, physique etc.) of the driver who appears in driver images may also be stored.

If the autonomous driving mode cancel notification signal is detected by the driving mode determining portion 12b, the trained classifier creating portion 12p performs processing to read out the definition information and constant data from the classifier information storage portion 13h, and create a trained classifier by using the read definition information and constant data. The trained classifier is constituted by a neural network, and includes an input layer to which driver image data that is read out from the image storage portion 13a is input, and an output layer that outputs determination data regarding whether or not the steering wheel 52 is being gripped by the driver's hand. The neural network may be a hierarchical neural network, or may also be a convolutional neural network.

The determination processing portion 12r is configured to perform processing to input pixel data of the driver image to the input layer of the created trained classifier, and output, from the output layer, the determination data regarding whether or not the steering wheel 52 is being gripped by the driver.

With the driver monitoring apparatus 10C according to Embodiment (4) described above, if the autonomous driving mode is to be switched to the manual driving mode, the definition information and constant data of the untrained classifier stored in the classifier information storage portion 13h are read out, a trained classifier is created, and driver image data is input to the input layer of the created trained classifier. Thus, determination data regarding whether or not the steering wheel 52 is being gripped by the driver's hand is output from the output layer.

Accordingly, a distinction can be made from a state where a passenger other than the driver is gripping the steering wheel 52, by using the trained classifier created by the trained classifier creating portion 12p. Thus, whether or not the original driver sitting in the driver seat is gripping the steering wheel 52 can be accurately detected.

(Note 1)

A driver monitoring apparatus that monitors a driver sitting in a driver seat in a vehicle provided with an autonomous driving mode and a manual driving mode, the apparatus including;

a memory including an image storage portion for storing a driver image captured by an image capturing portion for capturing an image of the driver; and

at least one hardware processor connected to the memory,

wherein, if the autonomous driving mode is to be switched to the manual driving mode, the at least one hardware processor

acquires the driver image captured by the image capturing portion and causes the image storage portion to store the acquired driver image,

reads out the driver image from the image storage portion,

processes the read driver image to determine whether or not a steering wheel of the vehicle is being gripped by a hand of the driver, and

outputs a predetermined signal that is based on a result of the determination.

(Note 2)

A driver monitoring method for monitoring a driver of a vehicle provided with an autonomous driving mode and a manual driving mode, by using an apparatus that includes a memory including an image storage portion for storing a driver image captured by an image capturing portion for capturing an image of the driver sitting in a driver seat, and at least one hardware processor connected to the memory, the method including:

acquiring the driver image captured by the image capturing portion if the autonomous driving mode is to be switched to the manual driving mode, by the at least one hardware processor;

causing the image storage portion to store the acquired driver image, by the at least one hardware processor;

reading out the driver image from the image storage portion, by the at least one hardware processor;

processing the read driver image and determining whether or not a steering wheel of the vehicle is being gripped by a hand of the driver, by the at least one hardware processor; and

outputting a predetermined signal that is based on a result of the determination, by the at least one hardware processor.

1. A driver monitoring apparatus that monitors a driver sitting in a driver seat in a vehicle provided with an autonomous driving mode and a manual driving mode, the apparatus comprising:
an image acquiring portion configured to acquire a driver image captured by an image capturing portion for capturing an image of the driver;
an image storage portion configured to store the driver image acquired by the image acquiring portion;
a determination processing portion configured to, if the autonomous driving mode is to be switched to the manual driving mode, process the driver image read out from the image storage portion to determine whether or not a steering wheel of the vehicle is being gripped by a hand of the driver; and
a signal output portion configured to output a predetermined signal that is based on a result of the determination performed by the determination processing portion.

2. The driver monitoring apparatus according to claim 1,
wherein the driver image is an image obtained by capturing an image of a field of view, which at least includes a portion of a shoulder to an upper arm of the driver, and a portion of the steering wheel, and
the determination processing portion comprises:
a gripping position detecting portion configured to process the driver image to detect a gripping position on the steering wheel;
a position detecting portion configured to process the driver image to detect a position of a shoulder and arm of the driver; and
a gripping determining portion configured to determine whether or not the steering wheel is being gripped by the hand of the driver, based on the gripping position detected by the gripping position detecting portion, and the position of the shoulder and arm of the driver detected by the position detecting portion.

3. The driver monitoring apparatus according to claim 1,
wherein the driver image is an image obtained by capturing an image of a field of view, which at least includes a portion of a shoulder to an upper arm of the driver,
the driver monitoring apparatus further comprises a contact signal acquiring portion configured to acquire a signal from a contact detecting portion that is provided in the steering wheel and detects contact with a hand, and
the determination processing portion comprises:
a gripping position detecting portion configured to detect a gripping position on the steering wheel based on the contact signal acquired by the contact signal acquiring portion;
a position detecting portion configured to process the driver image to detect a position of a shoulder and arm of the driver; and
a gripping determining portion configured to determine whether or not the steering wheel is being gripped by the hand of the driver, based on the gripping position detected by the gripping position detecting portion, and the position of the shoulder and arm of the driver detected by the position detecting portion.

4. The driver monitoring apparatus according to claim 2,
wherein, if the gripping position is not detected by the gripping position detecting portion, the signal output portion outputs a signal for causing a warning portion provided in the vehicle to execute warning processing for making the driver grip the steering wheel.

5. The driver monitoring apparatus according to claim 1, further comprising:
a classifier storage portion configured to store a trained classifier created by performing, in advance, learning processing by using, as training data, images of the driver who is gripping the steering wheel and images of the driver who is not gripping the steering wheel,
wherein the trained classifier includes an input layer to which data of the driver image read out from the image storage portion is input, and an output layer that outputs determination data regarding whether or not the steering wheel is being gripped by the hand of the driver, and
if the autonomous driving mode is to be switched to the manual driving mode, the determination processing portion performs processing to input the data of the driver image to the input layer of the trained classifier read out from the classifier storage portion, and output, from the output layer, the determination data regarding whether or not the steering wheel is being gripped by the hand of the driver.

6. The driver monitoring apparatus according to claim 1, further comprising:
a classifier information storage portion configured to store definition information regarding an untrained classifier including the number of layers in a neural network, the number of neurons in each layer, and a transfer function, and constant data including a weight and a threshold for neurons in each layer obtained, in advance, through learning processing; and
a trained classifier creating portion configured to read out the definition information and the constant data from the classifier information storage portion to create a trained classifier,
wherein the trained classifier includes an input layer to which data of the driver image read out from the image storage portion is input, and an output layer that outputs determination data regarding whether or not the steering wheel is being gripped by the hand of the driver, and
if the autonomous driving mode is to be switched to the manual driving mode, the determination processing portion performs processing to input the data of the driver image to the input layer of the trained classifier created by the trained classifier creating portion, and output, from the output layer, the determination data regarding whether or not the steering wheel is being gripped by the hand of the driver.

7. The driver monitoring apparatus according to claim 1,
wherein, if it is determined by the determination processing portion that the steering wheel is being gripped by the hand of the driver, the signal output portion outputs a signal for permitting switching from the autonomous driving mode to the manual driving mode.

8. The driver monitoring apparatus according to claim 1,
wherein, if it is determined by the determination processing portion that the steering wheel is not being gripped by the hand of the driver, the signal output portion outputs a signal for not permitting switching from the autonomous driving mode to the manual driving mode.

9. A driver monitoring method for monitoring a driver sitting in a driver seat in a vehicle provided with an autonomous driving mode and a manual driving mode, by using an apparatus including a storage portion and a hardware processor connected to the storage portion,
the storage portion including an image storage portion configured to store a driver image captured by an image capturing portion for capturing an image of the driver,
the method comprising:
acquiring the driver image captured by the image capturing portion, by the hardware processor, if the autonomous driving mode is to be switched to the manual driving mode;
causing the image storage portion to store the acquired driver image, by the hardware processor;
reading out the driver image from the image storage portion, by the hardware processor;
processing the read driver image to determine whether or not a steering wheel of the vehicle is being gripped by a hand of the driver, by the hardware processor; and
outputting a predetermined signal that is based on a result of the determination, by the hardware processor.

10. The driver monitoring apparatus according to claim 3,
wherein, if the gripping position is not detected by the gripping position detecting portion, the signal output portion outputs a signal for causing a warning portion provided in the vehicle to execute warning processing for making the driver grip the steering wheel.

11. The driver monitoring apparatus according to claim 2,
wherein, if it is determined by the determination processing portion that the steering wheel is being gripped by the hand of the driver, the signal output portion outputs a signal for permitting switching from the autonomous driving mode to the manual driving mode.

12. The driver monitoring apparatus according to claim 2,
wherein, if it is determined by the determination processing portion that the steering wheel is not being gripped by the hand of the driver, the signal output portion outputs a signal for not permitting switching from the autonomous driving mode to the manual driving mode.

13. The driver monitoring apparatus according to claim 3,
wherein, if it is determined by the determination processing portion that the steering wheel is being gripped by the hand of the driver, the signal output portion outputs a signal for permitting switching from the autonomous driving mode to the manual driving mode.

14. The driver monitoring apparatus according to claim 3,
wherein, if it is determined by the determination processing portion that the steering wheel is not being gripped by the hand of the driver, the signal output portion outputs a signal for not permitting switching from the autonomous driving mode to the manual driving mode.

15. The driver monitoring apparatus according to claim 4,
wherein, if it is determined by the determination processing portion that the steering wheel is being gripped by the hand of the driver, the signal output portion outputs a signal for permitting switching from the autonomous driving mode to the manual driving mode.

16. The driver monitoring apparatus according to claim 4,
wherein, if it is determined by the determination processing portion that the steering wheel is not being gripped by the hand of the driver, the signal output portion outputs a signal for not permitting switching from the autonomous driving mode to the manual driving mode.

17. The driver monitoring apparatus according to claim 10,
wherein, if it is determined by the determination processing portion that the steering wheel is being gripped by the hand of the driver, the signal output portion outputs a signal for permitting switching from the autonomous driving mode to the manual driving mode.

18. The driver monitoring apparatus according to claim 10,
wherein, if it is determined by the determination processing portion that the steering wheel is not being gripped by the hand of the driver, the signal output portion outputs a signal for not permitting switching from the autonomous driving mode to the manual driving mode.
